(19) United States
(12) Patent Application Publication
(10) Pub. No.: US 2025/0262027 A1
(43) Pub. Date: Aug. 21, 2025

(54) DENTAL AUXILIARIES FOR EFFECTIVE DENTAL APPLIANCE RETENTION

(71) Applicant: Align Technology, Inc., San Jose, CA (US)

(72) Inventors: Ryan Kimura, San Jose, CA (US); Jun Sato, San Jose, CA (US); Yuxiang Wang, Newark, CA (US); Jeffrey McGuire, Raleigh, NC (US); Xirui Peng, Apex, NC (US); Kangning Su, Pullman, WA (US); Manlio Fabio Valdivieso Casique, Santa Clara, CA (US); Jeremy Riley, Mountain View, CA (US)

(21) Appl. No.: 19/054,536

(22) Filed: Feb. 14, 2025

Related U.S. Application Data
(60) Provisional application No. 63/554,565, filed on Feb. 16, 2024.

(51) Int. Cl. A61C 7/00; A61C 7/10

(52) U.S. Cl. CPC A61C 7/002; A61C 7/10

(57) ABSTRACT

Devices, systems, and methods for expanding a patient's palate are provided. In some embodiments, a system for designing a dental system for expanding a palate of a patient includes one or more processors configured to perform operations including: accessing patient data representing one or more characteristics of the patient; accessing dental system data representing a palatal expander and a dental auxiliary for the patient, where the dental auxiliary is configured to be coupled to a tooth and to retain the palatal expander on a dental arch of the patient; determining whether a force applied to the dental auxiliary during placement or removal of the palatal expander is likely to cause detachment of the dental auxiliary from the tooth; modifying the dental system data to reduce the applied force; and generating one or more of a digital representation of the palatal expander or a digital representation of the dental auxiliary.

### CROSS-REFERENCE TO RELATED APPLICATION(S)

The present application claims the benefit of priority to U.S. Provisional Application No. 63/554,565, filed Feb. 16, 2024, which is incorporated by reference herein in its entirety.

### TECHNICAL FIELD

The present technology generally relates to dental and orthodontic treatment, and in particular, to dental auxiliaries for retention of dental appliances (e.g., palatal expanders).

### BACKGROUND

Dental appliances are used to treat various dental conditions, such as dental malocclusions, jaw dysfunction/misalignment, functional and/or aesthetic conditions, endodontic conditions, and others. For example, palatal expansion devices may be used to expand the roof of a patient's mouth and widen the patient's upper jaw to address conditions such as crossbite, crowding, or impacted teeth. Conventional non-removable palatal expansion devices typically use a jackscrew-type mechanism that delivers horizontal forces to the patient's molars to split the upper jaw along the midpalatal suture. Such devices may interfere with the patient's speech and eating, may cause significant pain due to the large forces involved, and may not be aesthetically pleasing to wear. Patient-removable palatal expansion devices can address some of these concerns, but proper placement and retention of such devices on the patient's teeth may be challenging. Although dental attachments bonded to the patient's teeth can be helpful for device retention, the presence of such attachments may interfere with placement of the device on the teeth and/or removal of the device from the teeth. Moreover, excessively high placement and/or removal forces can cause the attachments to detach from the teeth.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1A is a perspective view of a palatal expander configured in accordance with embodiments of the present technology.

FIG. 1B is a bottom view of an upper dental arch of a patient including dental auxiliaries, in accordance with embodiments of the present technology.

FIG. 1C illustrates the palatal expander of FIG. 1A on the dental arch of FIG. 1B, in accordance with embodiments of the present technology.

FIG. 2 is a partially schematic side cross-sectional view of a portion of a dental system including a palatal expander, a lingual dental auxiliary, and a buccal dental auxiliary, in accordance with embodiments of the present technology.

FIG. 3A is a side cross-sectional view of a partial ellipsoidal lingual dental auxiliary on a tooth, in accordance with embodiments of the present technology.

FIG. 3B is a side cross-sectional view of an angled lingual dental auxiliary on a tooth, in accordance with embodiments of the present technology.

FIG. 3C is a side cross-sectional view of a beveled lingual dental auxiliary on a tooth, in accordance with embodiments of the present technology.

FIG. 3D is a side cross-sectional view of a partial ellipsoidal lingual dental auxiliary with a truncated end on a tooth, in accordance with embodiments of the present technology.

FIG. 3E is a side cross-sectional view of a beveled lingual dental auxiliary on a tooth, in accordance with embodiments of the present technology.

FIG. 3F is a side cross-sectional view of a beveled lingual dental auxiliary on a tooth, in accordance with embodiments of the present technology.

FIG. 4A illustrates a tooth including a lingual dental auxiliary and a buccal dental auxiliary, in accordance with embodiments of the present technology.

FIG. 4B illustrates a tooth including a lingual dental auxiliary and a buccal dental auxiliary, in accordance with embodiments of the present technology.

FIG. 5A is a flow diagram illustrating a method for designing a dental system for expanding a patient's palate, in accordance with embodiments of the present technology.

FIG. 5B is a flow diagram illustrating a method for designing a dental system for expanding a patient's palate, in accordance with embodiments of the present technology.

FIG. 6A illustrates digital representations of a palatal expander and teeth for simulating forces during placement of the palatal expander on the teeth.

FIG. 6B illustrates simulated forces applied by the palatal expander of FIG. 6A to a first dental auxiliary on a first tooth during placement of the palatal expander.

FIG. 6C illustrates simulated forces applied by the palatal expander of FIG. 6A to a second dental auxiliary on a second tooth during placement of the palatal expander.

FIG. 7 is a flow diagram illustrating a method for designing a dental system for expanding a patient's palate, in accordance with embodiments of the present technology.

FIG. 8A is a side view of a dental auxiliary on a tooth and illustrates modifications that may be made to the dental auxiliary, in accordance with embodiments of the present technology.

FIG. 8B is a front view of the dental auxiliary of FIG. 8A on the tooth and illustrates modifications that may be made to the dental auxiliary, in accordance with embodiments of the present technology.

FIG. 8C is a front view of the dental auxiliary of FIG. 8A on the tooth and illustrates modifications that may be made to the dental auxiliary, in accordance with embodiments of the present technology.

FIG. 9A is a side cross-sectional view of a portion of a palatal expander and illustrates modifications that may be made to the palatal expander, in accordance with embodiments of the present technology.

FIG. 9B is a side cross-sectional view of a portion of a palatal expander and illustrates modifications that may be made to the palatal expander, in accordance with embodiments of the present technology.

FIG. 9C is a perspective view of a portion of a palatal expander and illustrates modifications that may be made to the palatal expander, in accordance with embodiments of the present technology.

FIG. 9D is a side cross-sectional view of a portion of a palatal expander and illustrates modifications that may be made to the palatal expander, in accordance with embodiments of the present technology.

FIG. 9E is a side cross-sectional view of a portion of a palatal expander and illustrates modifications that may be made to the palatal expander, in accordance with embodiments of the present technology.

FIG. 10A is a cross-sectional view of a portion of a palatal expander with an initial design, in accordance with embodiments of the present technology.

FIG. 10B is a cross-sectional view of the portion of the palatal expander of FIG. 10A with a modified design, in accordance with embodiments of the present technology.

FIG. 10C is a closeup view of the modified portion of the palatal expander of FIG. 10B, in accordance with embodiments of the present technology.

FIG. 10D is a closeup view of the modified portion of the palatal expander of FIG. 10B, in accordance with embodiments of the present technology.

FIG. 11A is a flow diagram illustrating a workflow for designing a dental system, in accordance with embodiments of the present technology.

FIG. 11B is a flow diagram illustrating a workflow for designing a dental system, in accordance with embodiments of the present technology.

FIG. 11C is a flow diagram illustrating a workflow for designing a dental system, in accordance with embodiments of the present technology.

FIG. 11D is a flow diagram illustrating a workflow for designing a dental system, in accordance with embodiments of the present technology.

FIG. 11E is a flow diagram illustrating a workflow for designing a dental system, in accordance with embodiments of the present technology.

FIG. 12A illustrates a representative example of a tooth repositioning appliance configured in accordance with embodiments of the present technology.

FIG. 12B illustrates a tooth repositioning system including a plurality of appliances, in accordance with embodiments of the present technology.

FIG. 12C illustrates a method of orthodontic treatment using a plurality of appliances, in accordance with embodiments of the present technology.

FIG. 13 illustrates a method for designing an orthodontic appliance, in accordance with embodiments of the present technology.

FIG. 14 illustrates a method for digitally planning an orthodontic treatment and/or design or fabrication of an appliance, in accordance with embodiments of the present technology.

### DETAILED DESCRIPTION

The present technology relates to devices, systems, and methods for expanding a patient's palate. In some embodiments, for example, a dental system of the present technology includes a palatal expander configured to be placed on a dental arch of a patient to expand the patient's palate, and at least one dental auxiliary configured to facilitate retention of the palatal expander on the dental arch. For example, the dental auxiliary can be a dental attachment, button, bracket, etc., that is coupled to a surface of a tooth to engage a corresponding portion of the palatal expander. In some embodiments, the dental auxiliary is configured to be placed on a lingual surface of a tooth, which may be beneficial, for example, for preventing the palatal expander from slipping out of place when the patient has buccally-inclined teeth, short crowns, a short palate depth, and/or other characteristics that are associated with poor retention of the palatal expander on the teeth. A lingually-positioned auxiliary may be used alone or in combination with other auxiliaries on the patient's teeth (e.g., buccally-positioned auxiliaries) to ensure that the palatal expander remains in place and that the forces generated by the palatal expander are transmitted properly to the underlying teeth to effectively expand the patient's palate.

In some embodiments, the present technology provides computer-implemented methods for designing dental systems for expanding a patient's palate. For example, a method can include accessing patient data representing one or more characteristics of the patient (e.g., characteristics of the patient's dental arch, demographic information, treatment information) and dental system data representing a palatal expander and at least one dental auxiliary for the patient (e.g., geometry and/or properties of the palatal expander and dental auxiliary). The method can include determining, based on the patient data and the dental system data, whether a force applied to the dental auxiliary during placement and/or removal of the palatal expander is likely to cause the dental auxiliary to detach from the underlying tooth. Excessive forces may arise, for example, due to interference between the palatal expander and the dental auxiliary during placement and/or removal, stiffness of the palatal expander proximate to the dental auxiliary, and/or imbalanced force distribution across dental auxiliaries bonded to neighboring teeth. If an excessive applied force is predicted to occur, the dental system data can be modified to reduce the applied force, such as by modifying the geometry and/or properties of the palatal expander and/or dental auxiliary. The determining and modifying processes can be iterated until a design for the palatal expander and dental auxiliary that is likely to avoid detachment of the dental auxiliary is achieved.

The present technology can provide various advantages compared to conventional devices and methods for palatal expansion. For instance, patient-removable palatal expanders may be more convenient, comfortable, and/or aesthetically pleasing than non-removable expanders. However, removable palatal expanders may be more prone to slipping off the teeth than other types of dental appliances due to the relatively large lateral forces needed to expand the palatal suture. Moreover, to produce and sustain such large forces, removable palatal expanders may be stiffer than other types of dental appliances, which may make it challenging for the patient to properly place the palatal expander on the teeth and/or to easily remove the palatal expander from the teeth. Although dental attachments and/or other types of dental auxiliaries bonded to the teeth can be used to engage the palatal expander to prevent slipping, the presence of such dental auxiliaries can make it more difficult to place and/or remove the palatal expander, since the palatal expander may need to be bent to fit around the dental auxiliaries. Furthermore, if excessive forces are applied to the dental auxiliary during placement and/or removal of the palatal expander, e.g., due to the stiffness of the palatal expander, the dental auxiliary may be damaged or become detached from the tooth.

To overcome these and other challenges, the dental auxiliaries and palatal expanders described herein can be configured to prevent slipping of the palatal expander from the teeth, while maintaining sufficiently low placement and removal forces to avoid detaching the dental auxiliaries from the teeth and/or to allow the patient to easily place and remove the palatal expander as desired. This can be accomplished, for example, by using additional dental auxiliaries (e.g., lingually-placed dental auxiliaries) to provide more secure engagement with the palatal expander, and/or by adjusting the shapes of the dental auxiliaries and/or palatal expander to enhance retention forces while reducing placement and removal forces. In some embodiments, the dental auxiliaries and/or palatal expander are adaptively designed using software algorithms that account for the patient's anatomy, demographics, treatment history, treatment prescription, and/or other relevant patient-specific factors. The approaches described herein can be used to produce more convenient, effective, and customized treatment, while avoiding complications that may interfere with treatment compliance.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

Although some embodiments of the present technology are described herein in connection with palatal expanders, this is not intended to be limiting, and the same techniques and systems can be applied to other types of dental appliances (e.g., aligners, retainers, mouthguards).

The headings provided herein are for convenience only and do not interpret the scope or meaning of the claimed present technology. Embodiments under any one heading may be used in conjunction with embodiments under any other heading.

### I. Devices, Systems, and Methods for Palatal Expansion

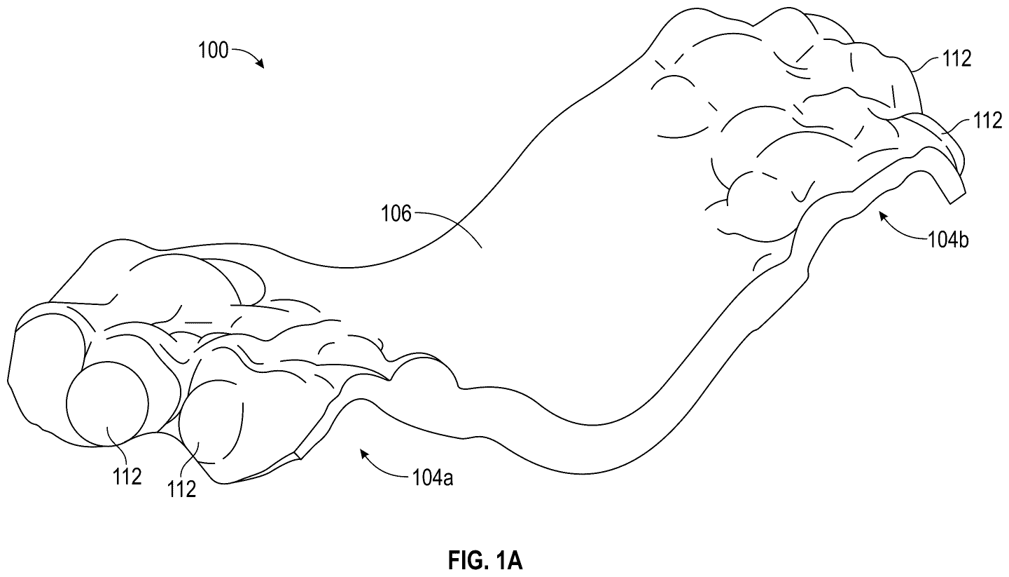

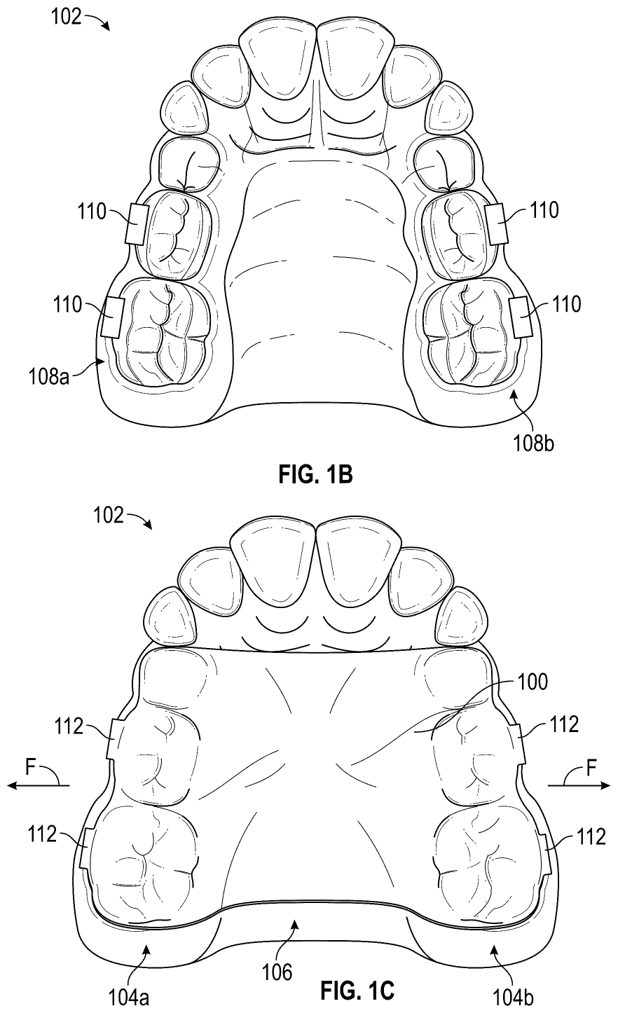

FIGS. 1A-1C illustrate a dental system for expanding a patient's palate, in accordance with embodiments of the present technology. Specifically, FIG. 1A is a perspective view of a palatal expander 100, FIG. 1B is a bottom view of an upper dental arch 102 of a patient, and FIG. 1C illustrates the palatal expander 100 on the dental arch 102. The palatal expander 100 can be a polymeric dental appliance including a first tooth engagement portion 104a, a second tooth engagement portion 104b, and a palatal portion 106 between the first tooth engagement portion 104a and the second tooth engagement portion 104b. As best seen in FIGS. 1B and 1C, the first tooth engagement portion 104a is configured to receive one or more first teeth 108a at a first side of the dental arch 102, and the second tooth engagement portion 104b is configured to receive one or more second teeth 108b at a second, opposite side of the dental arch 102. The first teeth 108a and the second teeth 108b received by the first tooth engagement portion 104a and the second tooth engagement portion 104b, respectively, can include some or all of the posterior teeth, such as one or more molars and/or premolars. For example, the first teeth 108a and the second teeth 108b can be the three distalmost teeth on each side of the dental arch 102.

In the illustrated embodiment, the first tooth engagement portion 104a and the second tooth engagement portion 104b each include a set of cavities formed therein to receive the first teeth 108a and the second teeth 108b, respectively. An individual cavity may receive a tooth by, for example, receiving and/or extending over only a portion of the tooth, such as the crown of the tooth, a portion of the tooth proximate to the crown, a buccal surface of the tooth, a lingual surface of the tooth, etc. The interior surfaces of the cavity can conform to the occlusal, lingual, and/or buccal surfaces of the received tooth.

The palatal portion 106 is positioned between the first tooth engagement portion 104a and the second tooth engagement portion 104b to couple these components to each other. When the palatal expander 100 is worn on the dental arch 102, the palatal portion 106 can be positioned proximate to the palate of the patient (e.g., spaced apart from some or all of the palatal surface, or in direct contact with some or all of the palatal surface). The palatal portion 106 can be configured to apply forces to the first tooth engagement portion 104a and the second tooth engagement portion 104b that are transmitted to the first teeth 108a and the second teeth 108b, respectively, to cause expansion of the patient's palate. In some embodiments, the width of the palatal portion 106 is greater than the width of the dental arch 102 when the palatal expander 100 is worn on the patient's teeth, and the stiffness of the palatal portion 106 (e.g., which may vary according to the thickness and material properties of the palatal portion 106) is sufficiently high to generate and maintain a sufficient amount of force to cause expansion of the palate. The forces produced by the palatal portion 106 can be generally directed in a horizontal, outward (buccal) direction, e.g., as indicated by arrows F in FIG. 1C. The magnitude of the forces for effective palatal expansion may be significantly greater than those typically needed for other types of dental/orthodontic treatment procedures. For instance, the forces can be at least 10 N, 20 N, 30 N, 40 N, 50 N, or 60 N; and/or within a range from 20 N to 60 N, or from 40 N to 60 N. These relatively large forces can present challenges with retention of the palatal expander 100 on the dental arch 102, as well as ease of placement/removal of the palatal expander 100, as discussed further herein.

In some embodiments, the palatal expander 100 is used in combination with one or more dental auxiliaries 110 that are coupled to one or more teeth of the dental arch 102 to engage the palatal expander 100, such as the first tooth engagement portion 104a and/or the second tooth engagement portion 104b. For example, the dental auxiliaries 110 can be dental attachments (e.g., prefabricated attachments or attachments formed in situ) that are bonded to the surfaces of the patient's teeth. Other types of dental auxiliaries 110 that may be used include buttons, brackets, pins, connectors, wires, etc. The engagement between the dental auxiliaries 110 and the palatal expander 100 can serve various purposes, such as facilitating retention of the palatal expander 100 on the dental arch, improving transfer of expansion forces from the palatal expander 100 to the underlying teeth, and/or counteracting undesirable tooth movements that might otherwise occur due to expansion forces (e.g., tipping).

The geometry of the dental auxiliaries 110 can be configured to produce secure engagement with the palatal expander 100, while avoiding excessively large forces during placement of the palatal expander 100 on the dental arch 102 and/or removal of the palatal expander 100 from the dental arch 102. The dental auxiliaries 110 can each independently have any suitable shape, such as a polyhedral shape (e.g., cuboidal or other prismatic shape with flattened polygonal surfaces), a rounded shape (e.g., ellipsoidal, spherical, or other shape with rounded surfaces), or suitable combinations thereof (e.g., a first surface of a dental auxiliary 110 can be rounded and a second surface of the dental auxiliary 110 can be flattened). Additional examples of geometries that may be used for the dental auxiliaries 110 are described further below.

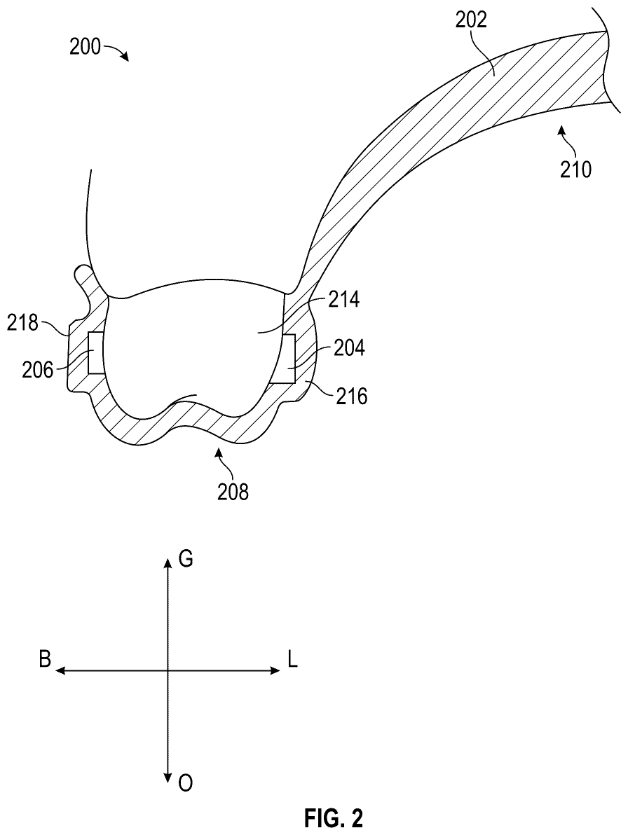

The number and configuration of the dental auxiliaries 110 on the dental arch 102 can be varied as desired. For example, although the illustrated embodiment shows four dental auxiliaries 110 (e.g., two dental auxiliaries 110 on the first teeth 108a and two dental auxiliaries 110 on the second teeth 108b), in other embodiments, a different number of dental auxiliaries 110 can be used, such as one, two, three, five, six, seven, eight, or more dental auxiliaries 110. In some embodiments, multiple attachments may be placed on a single tooth. For example, two or three attachments (e.g., buccal attachments) may be placed on the terminal molar (e.g., the most distal molar of the patient) for balancing loads and providing increased retention. These attachments may be smaller in size relative to other attachments to enable placement on a single tooth. Moreover, although the dental auxiliaries 110 are depicted as being placed on the two distalmost teeth on each side of the dental arch 102, the dental auxiliaries 110 can alternatively or additionally be placed on any other teeth received by the palatal expander 100, either the first side or the second side of the dental arch 102 may not include any dental auxiliaries, etc. Furthermore, although the dental auxiliaries 110 are shown as being placed on the buccal surfaces of the teeth, the dental auxiliaries 110 can alternatively or additionally be placed on other suitable surfaces of the teeth, such as the lingual surfaces of the teeth (e.g., as described further below in connection with FIGS. 2-5), the occlusal surfaces of the teeth, or suitable combinations thereof. The geometry (e.g., shape, dimensions) of each dental auxiliary 110 can independently be varied as desired, e.g., some or all of the dental auxiliaries 110 may have different shapes, or some or all of the dental auxiliaries 110 can have the same shape. As discussed further herein, the number, geometry, and locations of the dental auxiliaries 110 can be configured for various purposes, such as facilitating retention of the palatal expander 100 on the dental arch 102, allowing the palatal expander 100 to be easily placed on the dental arch 102, allowing the palatal expander 100 to be easily removed from the dental arch 102, and/or avoiding excessive forces during placement and/or removal of the palatal expander 100 that might cause some or all of the dental auxiliaries 110 to detach from the teeth.

In some embodiments, the palatal expander 100 includes one or more receptacles 112 (e.g., recesses, apertures, indentations, pockets) to receive and engage the dental auxiliaries 110. For example, the first tooth engagement portion 104a can include one or more first receptacles 112 formed therein to receive one or more dental auxiliaries 110 on the first teeth 108a, and/or the second tooth engagement portion 104b can include one or more second receptacles 112 formed therein to receive one or more dental auxiliaries 110 on the second teeth 108b. Each receptacle 112 can be formed in a sidewall of a cavity for a tooth having the corresponding dental auxiliary 110, such that when the tooth is received within the cavity, the dental auxiliary 110 on the tooth is positioned partially or entirely within the receptacle 112. The interior surface of the receptacle 112 can conform partially or entirely to the exterior surface of the received dental auxiliary 110 to provide mating engagement between the receptacle 112 and the dental auxiliary 110. In some embodiments, certain portions of the interior surface of the receptacle 112 directly engage a surface of the dental auxiliary 110 (also referred to herein as “working surfaces”), while other portions of the interior surface of the receptacle 112 do not directly engage a surface of the dental auxiliary 110 (also referred to herein as “non-working surfaces”).

The number, geometry, and locations of the receptacles 112 in the palatal expander 100 can correspond to the number, geometry, and locations of the dental auxiliaries 110 on the dental arch 102. In the illustrated embodiment, for example, the palatal expander 100 includes four receptacles 112 at the buccal surface of the first tooth engagement portion 104a and the second tooth engagement portion 104b to receive the four dental auxiliaries 110 on the buccal surfaces of first teeth 108a and the second teeth 108b, respectively. In other embodiments, however, some or all of the receptacles 112 can be configured differently depending on the configuration of the corresponding dental auxiliaries 110, e.g., the palatal expander 100 can alternatively or additionally include one or more receptacles 112 on other surfaces of the first tooth engagement portion 104a and/or the second tooth engagement portion 104b (e.g., lingual surfaces, occlusal surfaces), the palatal expander 100 can include fewer or more receptacles 112, etc.

The palatal expander 100 can be one of a series of palatal expanders configured to incrementally expand the patient's palate from a first width toward a second width in a plurality of treatment stages. Each palatal expander in the series can be generally similar to the palatal expander 100 shown in FIGS. 1A-1C, but the design of the palatal expander can be customized to the particular treatment stage. For instance, different palatal expanders in the series can have palatal portions 106 with different geometries (e.g., widths, thicknesses) and/or different material properties, depending on the amount of expansion to be achieved during the corresponding treatment stage. Some or all of the palatal expanders in the series can be configured for use with the same dental auxiliaries 110 (e.g., some or all of the dental auxiliaries 110 can remain on the dental arch 102 across multiple treatment stages), or some or all of the palatal expanders in the series can be configured for use with different dental auxiliaries 110 (e.g., some or all of the dental auxiliaries 110 may be removed and/or replaced with other dental auxiliaries 110 for different treatment stages).

Certain patient characteristics may be associated with poor retention of a palatal expander on the patient's dental arch. Poor retention may occur, for example, if the palatal expander tends to slip away from the palate and/or off of the received teeth, and/or if the palatal expander tends to disengage from the dental auxiliaries on the patient's teeth. For instance, if some or all of the teeth received by the palatal expander (e.g., the posterior teeth) are inclined in a buccal direction (e.g., by an angle of at least 5 degrees, 6 degrees, 7 degrees, 8 degrees, 9 degrees, 10 degrees, 12 degrees, 15 degrees, or 20 degrees), the palatal expander may slip downward along the lingual surfaces of the teeth. Slippage may also occur if some or all of the teeth received by the palatal expander have short crown heights (e.g., depending on, for example, the patient, the tooth, and the application, a crown height less than less than 4 mm, less than 3 mm, less than 2 mm, etc.) and/or if the patient has a relatively shallow palate depth (e.g., a palate depth less than 5 mm, less than 4 mm, or less than 3 mm). Slipping of the palatal expander may result in improper force application on the patient's teeth (e.g., the forces may be too low for effective palatal expansion, may be applied to inappropriate locations on the dental arch, and/or the effective direction of the applied force may be suboptimal or not as designed), may interfere with the patient's activities (e.g., speaking, eating), and/or may cause discomfort.

To overcome these and other challenges, the present technology provides dental systems including a palatal expander and at least one dental auxiliary configured to be placed on a lingual surface of the patient's teeth to engage the palatal expander. In some embodiments, the use of one or more lingually-placed dental auxiliaries enhances retention of the palatal expander on the dental arch and reduces the incidence of slipping, e.g., compared to dental systems that use buccally-placed dental auxiliaries only. Lingually-placed dental auxiliaries may alternatively or additionally provide other benefits, such as enhanced control over forces applied to the lingual surfaces of the teeth and/or improved aesthetics (e.g., lingually-placed auxiliaries may be less visible than buccally-placed auxiliaries when the patient smiles).

FIG. 2 is a partially schematic side cross-sectional view of a portion of a dental system 200 including a palatal expander 202, a lingual dental auxiliary (“lingual auxiliary 204”), and a buccal dental auxiliary (“buccal auxiliary 206”), in accordance with embodiments of the present technology. The palatal expander 202 can be identical or generally similar to the palatal expander 100 of FIGS. 1A-1C, e.g., the palatal expander 202 can include a pair of tooth engagement portions 208 that receive teeth on opposite sides of the dental arch (a single tooth engagement portion 208 is shown in FIG. 2 for purposes of simplicity), and a palatal portion 210 that applies forces on the tooth engagement portions 208 to expand the patient's palate.

In the illustrated embodiment, the tooth engagement portion 208 includes a cavity configured to receive a tooth 214 that is bonded to the lingual auxiliary 204 and the buccal auxiliary 206. The cavity can include a receptacle formed in a lingual (L) side of the tooth engagement portion 208 (“lingual receptacle 216”) to receive the lingual auxiliary 204, and to a receptacle formed in a buccal (B) side of the tooth engagement portion 208 (“buccal receptacle 218”) to receive the buccal auxiliary 206. The lingual receptacle 216 can be shaped to conform to the lingual auxiliary 204 (e.g., the interior surfaces of the lingual receptacle 216 can be complementary to some or all of the exterior surfaces of the lingual auxiliary 204), and the buccal receptacle 218 can be shaped to conform to the buccal auxiliary 206 (e.g., the interior surfaces of the buccal receptacle 218 can be complementary to some or all of the exterior surfaces of the buccal auxiliary 206).

The lingual auxiliary 204 and the buccal auxiliary 206 can be configured to facilitate retention of the palatal expander 202 on the patient's teeth. In some embodiments, the lingual auxiliary 204 engages the lingual receptacle 216 of the palatal expander 202 to reduce or prevent slipping of the palatal expander 202 in an occlusal (O) direction away from the patient's palate (e.g., due to buccal inclination of the tooth 214, short crown height of the tooth 214, and/or shallow palate depth). The presence of the lingual auxiliary 204 in combination with the buccal auxiliary 206 may provide more effective retention of the palatal expander 202, e.g., compared to the buccal auxiliary 206 alone.

The geometry and/or location of the lingual auxiliary 204 and the buccal auxiliary 206 can each independently be configured to provide good retention of the palatal expander 202, while also allowing for easy placement of the palatal expander 202 on the patient's teeth and/or easy removal of the palatal expander 202 from the patient's teeth. Placement of the palatal expander 202 can involve applying forces to the palatal expander 202 along a gingival (G) direction until the tooth 214 is received within the cavity, and the lingual auxiliary 204 and buccal auxiliary 206 are received within the lingual receptacle 216 and buccal receptacle 218, respectively. The forces may be applied, for example, by pressing upward against the palatal expander 202 with the patient's fingers and/or by the patient biting down on the occlusal surfaces of the palatal expander 202. The ease of placement of the palatal expander 202 may depend on the amount of force needed to seat the palatal expander 202 properly on the teeth, which in turn may depend on the stiffness of the palatal expander 202, as well as contact between the occlusally-oriented surfaces of the lingual auxiliary 204 and the buccal auxiliary 206, and the palatal expander 202. As used herein, an “occlusally-oriented surface” may refer to a surface of a dental auxiliary that at least partially faces an occlusal direction and/or is located at an occlusal side of the dental auxiliary. In some embodiments, the geometry of the occlusally-oriented surfaces of the lingual auxiliary 204 and/or the buccal auxiliary 206 is configured to reduce interference with the palatal expander 202 during placement, as described further herein. The reduction in interference can be produced, for example, by reducing the amount of contact between the dental auxiliary and the palatal expander during placement and/or by reducing an amount of deformation of the palatal expander needed to slide the palatal expander over the dental auxiliary during placement.

Removal of the palatal expander 202 can involve applying forces to the palatal expander 202 along an occlusal direction until the tooth 214 is removed from the cavity, and the lingual auxiliary 204 and buccal auxiliary 206 are removed from the lingual receptacle 216 and buccal receptacle 218, respectively. The forces may be applied, for example, by pulling downward on the palatal expander 202 with the patient's fingers. The ease of removal of the palatal expander 202 may depend on the amount of force needed to displace the palatal expander 202 from the teeth, which in turn may depend on the stiffness of the palatal expander 202, as well as contact between the gingivally-oriented surfaces of the lingual auxiliary 204 and the buccal auxiliary 206, and the palatal expander 202. As used herein, a “gingivally-oriented surface” may refer to a surface of a dental auxiliary that at least partially faces a gingival direction and/or is located at a gingival side of the dental auxiliary. In some embodiments, the geometry of the gingivally-oriented surfaces of the lingual auxiliary 204 and/or the buccal auxiliary 206 is configured to reduce interference with the palatal expander 202 during removal, as described further herein. The reduction in interference can be produced, for example, by reducing the amount of contact between the dental auxiliary and the palatal expander during removal and/or by reducing an amount of deformation of the palatal expander needed to slide the palatal expander off the dental auxiliary during removal.

Alternatively or in combination, the reduction in interference during placement and/or removal can be achieved by adjusting the dimensions of the dental auxiliary, such as the length, width, prominence (e.g., maximum and/or average height above the tooth surface), etc., and/or by adjusting the position and/or orientation of the dental auxiliary on the tooth. For instance, a dental auxiliary with a smaller prominence may produce less interference than a dental auxiliary with a greater prominence. As another example, for dental auxiliaries with asymmetric shapes, certain orientations may produce more or less interference with the palatal expander.

Although FIG. 2 depicts a single tooth 214 with a lingual auxiliary 204 and a buccal auxiliary 206, the description herein is applicable to any of the teeth received by the palatal expander 202. For instance, some (e.g., one, two, three, four, five) or all of the teeth received by the palatal expander may include both a lingual auxiliary 204 and a buccal auxiliary 206. Optionally, some (e.g., one, two, three, four, five) or all of the received teeth may include a lingual auxiliary 204 only; some (e.g., one, two, three, four, five) of the received teeth may include a buccal auxiliary 206 only; and/or some (e.g., one, two, three, four, five) of the received teeth may not include any dental auxiliaries. In some embodiments, lingual auxiliaries 204 are used only on teeth where slippage of the palatal expander 202 is predicted to occur (e.g., teeth that are buccally-inclined and/or have short crowns), while the remaining teeth include buccal auxiliaries 206 only or no dental auxiliaries. Alternatively, lingual auxiliaries 204 may be used even if slippage is not predicted to occur. The configuration of the palatal expander 202 can be varied as appropriate to accommodate the dental auxiliaries used, e.g., the number, geometry, and locations of receptacles in the palatal expander 202 can vary according to the number, geometry, and locations of the dental auxiliaries on the teeth.

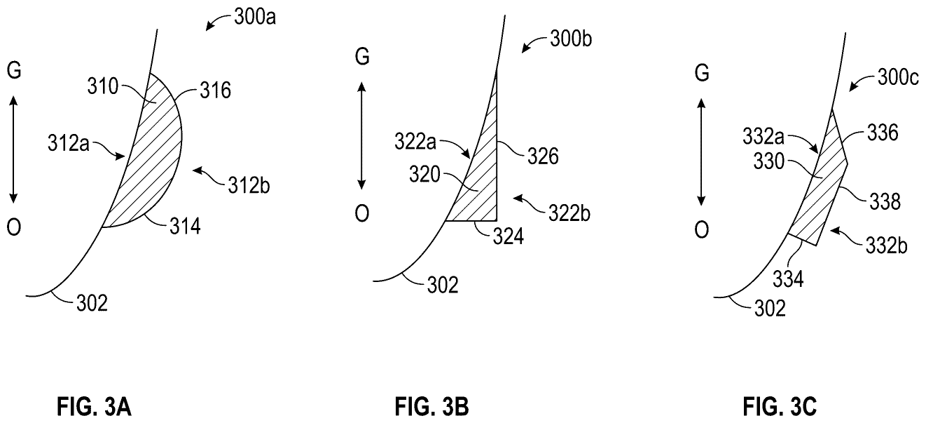

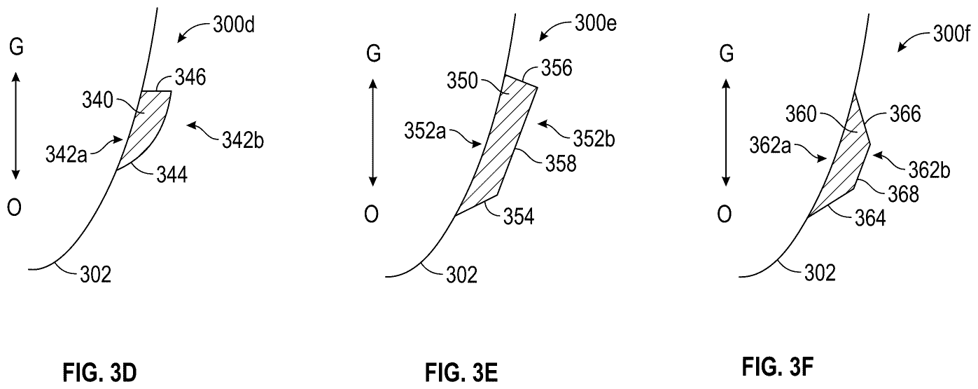

FIGS. 3A-3F illustrate various geometries that may be used for a lingual dental auxiliary, in accordance with embodiments of the present technology. The embodiments of FIGS. 3A-3F can be used in combination with any of the devices and systems described herein, such as the dental systems discussed in connection with FIGS. 1A-2. Moreover, the features of any of the embodiments of FIGS. 3A-3F can be combined with each other.

FIG. 3A is a side cross-sectional view of a lingual dental auxiliary (“lingual auxiliary 300a”) on a tooth 302, in accordance with embodiments of the present technology. The lingual auxiliary 300a can be a dental attachment, button, bracket, etc., having an auxiliary body 310 formed from a solid material (e.g., a polymer, metal, or composite). The auxiliary body 310 includes a first surface 312a configured to be coupled to the lingual surface of the tooth 302, and a second surface 312b (e.g., an exterior surface) opposite the first surface 312a. At least a portion of the second surface 312b can be configured to engage a corresponding surface of a palatal expander (e.g., the interior surface of a receptacle of the palatal expander) to facilitate retention of the palatal expander on the tooth 302, as described herein. In some embodiments, the second surface 312b includes an occlusally-oriented surface 314 that contacts the palatal expander during placement of the palatal expander on the tooth 302, and a gingivally-oriented surface 316 that contacts the palatal expander during removal of the palatal expander 202 from the tooth 302.

As shown in FIG. 3A, the auxiliary body 310 can have a rounded shape with a smooth continuous exterior curvature. For example, the auxiliary body 310 can have an ellipsoidal or partial ellipsoidal shape, a spherical or partial spherical shape, etc. Accordingly, the second surface 312b can be rounded to facilitate easy placement and/or removal of the palatal expander. In the illustrated embodiment, the occlusally-oriented surface 314 is rounded to reduce interference between the occlusally-oriented surface 314 and the palatal expander during placement of the palatal expander on the tooth 302; and the gingivally-oriented surface 316 is rounded to reduce interference between the gingivally-oriented surface 316 and the palatal expander during removal of the palatal expander from the tooth 302. The curvature of the occlusally-oriented surface 314 and the gingivally-oriented surface 316 can allow the palatal expander to slide smoothly along the auxiliary body 310 during placement and removal, respectively.

FIG. 3B is a side cross-sectional view of a lingual dental auxiliary (“lingual auxiliary 300b”) on a tooth 302, in accordance with embodiments of the present technology. The lingual auxiliary 300b includes an auxiliary body 320 having a first surface 322a configured to be coupled to the lingual surface of the tooth 302, and a second surface 322b (e.g., an exterior surface) opposite the first surface 322a, the second surface 322b including an occlusally-oriented surface 324 and a gingivally-oriented surface 326.

In some embodiments, the auxiliary body 320 of the lingual auxiliary 300b is shaped to allow for easy removal of the palatal expander from the tooth 302. As shown in FIG. 3B, the gingivally-oriented surface 326 is a generally planar surface that is angled in an occlusal direction to reduce interference with the palatal expander during removal of the palatal expander. Stated differently, the slope of the gingivally-oriented surface 326 relative to the surface of the underlying tooth 302 (e.g., corresponding to the interior angle of the gingival end of the lingual auxiliary 300b) can be less than or equal to 80°, 70°, 60°, 50°, 45°, 40°, 30°, 20°, 15°, 10°, or 5°. In some embodiments, the gingivally-oriented surface 326 is aligned with (e.g., parallel to) the gingival-occlusal axis, e.g., the angle between the gingivally-oriented surface 326 and the gingival-occlusal axis can be less than or equal to 20°, 15°, 10°, 5°, 2°, or 1°, or can be 0°.

In the illustrated embodiment, the occlusally-oriented surface 324 is a generally planar surface that is connected directly to the gingivally-oriented surface 326 and is orthogonal to the gingival-occlusal axis, such that the auxiliary body 320 has a generally triangular side-cross sectional shape. The angle between the occlusally-oriented surface 324 and the gingivally-oriented surface 326 can be an acute angle, an obtuse angle, or a right angle. In other embodiments, however, the occlusally-oriented surface 324 can be configured differently, e.g., the occlusally-oriented surface 324 may be rounded, may be at a different angle relative to the gingival-occlusal axis, etc., as described in connection with the other embodiments of FIGS. 3A-3F.

FIG. 3C is a side cross-sectional view of a lingual dental auxiliary (“lingual auxiliary 300c”) on a tooth 302, in accordance with embodiments of the present technology. The lingual auxiliary 300c includes an auxiliary body 330 having a first surface 332a configured to be coupled to the lingual surface of the tooth 302, and a second surface 332b (e.g., an exterior surface) opposite the first surface 332a. The second surface 332b can include an occlusally-oriented surface 334, a gingivally-oriented surface 336, and an intermediate surface 338 between the occlusally-oriented surface 334 and the gingivally-oriented surface 336.

In some embodiments, the auxiliary body 330 of the lingual auxiliary 300c has a beveled gingival end to allow for easy removal of the palatal expander from the tooth 302. As shown in FIG. 3C, the gingivally-oriented surface 336 of the auxiliary body 330 is a generally planar surface that is angled in an occlusal direction to reduce interference with the palatal expander during removal of the palatal expander. Stated differently, the slope of the gingivally-oriented surface 336 relative to the surface of the underlying tooth 302 (e.g., corresponding to the interior angle of the gingival end of the lingual auxiliary 300c) can be less than or equal to 80°, 70°, 60°, 50°, 45°, 40°, 30°, 20°, 15°, 10°, or 5°. In some embodiments, the gingivally-oriented surface 336 is aligned with (e.g., parallel to) the gingival-occlusal axis, e.g., the angle between the gingivally-oriented surface 336 and the gingival-occlusal axis can be less than or equal to 20°, 15°, 10°, 5°, 2°, or 1°, or can be 0°.

In the illustrated embodiment, the occlusally-oriented surface 334 is a generally planar surface that is connected to an intermediate surface 338, and the intermediate surface 338 is a generally planar surface that is connected to the gingivally-oriented surface 336, such that the auxiliary body 320 has a generally trapezoidal side-cross sectional shape. In other embodiments, however, the occlusally-oriented surface 334 and/or the intermediate surface 338 can be configured differently, e.g., any of these surfaces may be rounded, the angles of the surfaces can be varied as desired, etc., as described in connection with the other embodiments of FIGS. 3A-3F.

FIG. 3D is a side cross-sectional view of a lingual dental auxiliary (“lingual auxiliary 300d”) on a tooth 302, in accordance with embodiments of the present technology. The lingual auxiliary 300d includes an auxiliary body 340 having a first surface 342a configured to be coupled to the lingual surface of the tooth 302, and a second surface 342b (e.g., an exterior surface) opposite the first surface 342a, the second surface 342b including an occlusally-oriented surface 344 and a gingivally-oriented surface 346.

As shown in FIG. 3D, the occlusally-oriented surface 344 of the auxiliary body 340 has a rounded shape to reduce interference with the palatal expander during placement of the palatal expander. The gingivally-oriented surface 346 can be a generally planar surface that is connected to the occlusally-oriented surface 344, such that the auxiliary body 340 has a partial ellipsoidal shape with a truncated gingival end. In other embodiments, however, the gingivally-oriented surface 346 can be configured differently, e.g., the gingivally-oriented surface 346 can be rounded, the angle of the gingivally-oriented surface 346 relative to the occlusally-oriented surface 344 can be varied as desired, etc., as described in connection with the other embodiments of FIGS. 3A-3F. Moreover, in other embodiments, the configuration of the occlusally-oriented surface 344 and the gingivally-oriented surface 346 can be reversed, such that the gingivally-oriented surface 346 is a rounded surface and the occlusally-oriented surface 344 is a generally planar surface, e.g., to reduce interference with the palatal expander during removal of the palatal expander.

FIG. 3E is a side cross-sectional view of a lingual dental auxiliary (“lingual auxiliary 300e”) on a tooth 302, in accordance with embodiments of the present technology. The lingual auxiliary 300e includes an auxiliary body 350 having a first surface 352a configured to be coupled to the lingual surface of the tooth 302, and a second surface 352b (e.g., an exterior surface) opposite the first surface 352a. The second surface 352b can include an occlusally-oriented surface 354, a gingivally-oriented surface 356, and an intermediate surface 358 between the occlusally-oriented surface 354 and the gingivally-oriented surface 356.

In some embodiments, the auxiliary body 350 of the lingual auxiliary 300e has a beveled occlusal end to allow for easy placement of the palatal expander on the tooth 302. As shown in FIG. 3E, the occlusally-oriented surface 354 of the auxiliary body 350 is a generally planar surface that is angled in a gingival direction to reduce interference with the palatal expander during placement of the palatal expander. Stated differently, the slope of the occlusally-oriented surface 354 relative to the surface of the underlying tooth 302 (e.g., corresponding to the interior angle of the occlusal end of the lingual auxiliary 300e) can be less than or equal to 80°, 70°, 60°, 50°, 45°, 40°, 30°, 20°, 15°, 10°, or 5°. In some embodiments, the occlusally-oriented surface 354 is aligned with (e.g., parallel to) the gingival-occlusal axis, e.g., the angle between the occlusally-oriented surface 354 and the gingival-occlusal axis can be less than or equal to 20°, 15°, 10°, 5°, 2°, or 1°, or can be 0°.

In the illustrated embodiment, the gingivally-oriented surface 356 is a generally planar surface that is connected to an intermediate surface 358, and the intermediate surface 358 is a generally planar surface that is connected to the occlusally-oriented surface 354, such that the auxiliary body 350 has a generally trapezoidal side-cross sectional shape. In other embodiments, however, the gingivally-oriented surface 356 and/or the intermediate surface 358 can be configured differently, e.g., any of these surfaces may be rounded, the angles of the surfaces can be varied as desired, etc., as described in connection with the other embodiments of FIGS. 3A-3F.

FIG. 3F is a side cross-sectional view of a lingual dental auxiliary (“lingual auxiliary 300f”) on a tooth 302, in accordance with embodiments of the present technology. The lingual auxiliary 300f includes an auxiliary body 360 having a first surface 362a configured to be coupled to the lingual surface of the tooth 302, and a second surface 362b (e.g., an exterior surface) opposite the first surface 362a. The second surface 362b can include an occlusally-oriented surface 364, a gingivally-oriented surface 366, and an intermediate surface 368 between the occlusally-oriented surface 364 and the gingivally-oriented surface 366.

In some embodiments, the auxiliary body 360 of the lingual auxiliary 300f has beveled occlusal and gingival ends to allow for easy placement and removal of the palatal expander, respectively. As shown in FIG. 3F, the occlusally-oriented surface 364 of the auxiliary body 350 is a generally planar surface that is angled in a gingival direction to reduce interference with the palatal expander during placement of the palatal expander. Stated differently, the slope of the occlusally-oriented surface 364 relative to the surface of the underlying tooth 302 (e.g., corresponding to the interior angle of the occlusal end of the lingual auxiliary 300f) can be less than or equal to 80°, 70°, 60°, 50°, 45°, 40°, 30°, 20°, 15°, 10°, or 5°. In some embodiments, the occlusally-oriented surface 364 is aligned with (e.g., parallel to) the gingival-occlusal axis, e.g., the angle between the occlusally-oriented surface 364 and the gingival-occlusal axis can be less than or equal to 20°, 15°, 10°, 5°, 2°, or 1°, or can be 0°.

In some embodiments, the gingivally-oriented surface 366 of the auxiliary body 350 is a generally planar surface that is angled in an occlusal direction to reduce interference with the palatal expander during removal of the palatal expander. Stated differently, the slope of the gingivally-oriented surface 366 relative to the surface of the underlying tooth 302 (e.g., corresponding to the interior angle of the gingival end of the lingual auxiliary 300f) can be less than or equal to 80°, 70°, 60°, 50°, 45°, 40°, 30°, 20°, 15°, 10°, or 5°. In some embodiments, the gingivally-oriented surface 366 is aligned with (e.g., parallel to) the gingival-occlusal axis, e.g., the angle between the gingivally-oriented surface 366 and the gingival-occlusal axis can be less than or equal to 20°, 15°, 10°, 5°, 2°, or 1°, or can be 0°.

In the illustrated embodiment, the gingivally-oriented surface 366 is connected to an intermediate surface 368, and the intermediate surface 368 is a generally planar surface that is connected to the occlusally-oriented surface 364, such that the auxiliary body 360 has a generally trapezoidal side-cross sectional shape. In other embodiments, however, the any of these surfaces can be configured differently, e.g., any of these surfaces may be rounded, the angles of the surfaces can be varied as desired, etc., as described in connection with the other embodiments of FIGS. 3A-3F.

Moreover, although the embodiments of FIGS. 3A-3F are described above with respect to lingual dental auxiliaries, any of the embodiments of FIGS. 3A-3F can also be used for dental auxiliaries placed on other surfaces of the teeth, such as buccal dental auxiliaries. For instance, buccal auxiliaries can be modified as desired to reduce forces associated with placement and/or removal of the palatal expander, since use of buccal auxiliaries in combination with lingual auxiliaries may otherwise make challenging to place and/or remove the palatal expander.

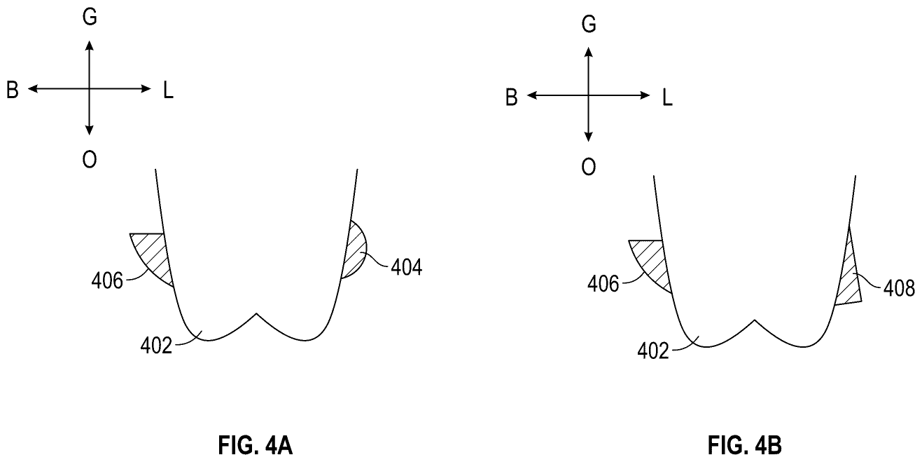

FIG. 4A illustrates a tooth 402 including a lingual dental auxiliary (“lingual auxiliary 404”) and a buccal dental auxiliary (“buccal auxiliary 406”), in accordance with embodiments of the present technology. The lingual auxiliary 404 and the buccal auxiliary 406 can be used in combination with any of the devices and systems described herein, such as the dental systems discussed in connection with FIGS. 1A-2. For example, the lingual auxiliary 404 and the buccal auxiliary 406 can be configured to engage a palatal expander to improve retention of the palatal expander on the tooth 402, e.g., compared to a dental system that uses only the buccal auxiliary 406 for retention.

In the illustrated embodiment, the lingual auxiliary 404 has a rounded shape (e.g., a partial ellipsoidal shape that is identical or similar to the shape of the auxiliary shown in FIG. 3A). The presence of the lingual auxiliary 404 on the tooth 402 can reduce or prevent slipping of palatal expander, while the rounded shape of the lingual auxiliary 404 can reduce the forces for placement and/or removal of the palatal expander, e.g., due to reduced interference between the surface of the lingual auxiliary 404 and the palatal expander, as described elsewhere herein.

The buccal auxiliary 406 can have a different shape than the lingual auxiliary 404. For instance, as shown in FIG. 4A, the buccal auxiliary 406 can have a partial ellipsoidal shape with a truncated gingival end. Specifically, the buccal auxiliary 406 can have a rounded occlusally-oriented surface and generally planar gingivally-oriented surface (e.g., identical or similar to the shape of the auxiliary shown in FIG. 3D). The rounded occlusally-oriented surface can facilitate placement of the palatal expander on the tooth 402, while the generally planar gingivally-oriented surface can reduce or prevent slipping of the palatal expander.

FIG. 4B illustrates a tooth 402 including another lingual dental auxiliary (“lingual auxiliary 408”) and the buccal auxiliary 406, in accordance with embodiments of the present technology. The lingual auxiliary 408 and the buccal auxiliary 406 can be used in combination with any of the devices and systems described herein, such as the dental systems discussed in connection with FIGS. 1A-2. For example, the lingual auxiliary 408 and the buccal auxiliary 406 can be configured to engage a palatal expander to improve retention of the palatal expander on the tooth 402, e.g., compared to a dental system that uses only the buccal auxiliary 406 for retention.

In the illustrated embodiment, the lingual auxiliary 408 has a generally triangular side cross-sectional shape (e.g., identical or similar to the shape of the auxiliary shown in FIG. 3B). The gingivally-oriented surface of the lingual auxiliary 408 can be a generally planar surface that is angled in an occlusal direction and/or aligned with (e.g., parallel to) the gingival-occlusal axis. The occlusally-oriented surface of the lingual auxiliary 408 can also be a generally planar surface and can be connected to the gingivally-oriented surface at any suitable angle (e.g., an acute angle, an obtuse angle, or a right angle). The presence of the lingual auxiliary 408 on the tooth 402 can reduce or prevent slipping of palatal expander, while the angled gingival end of the lingual auxiliary 408 can reduce the forces for placement and/or removal of the palatal expander, e.g., due to reduced interference between the surface of the lingual auxiliary 408 and the palatal expander, as described elsewhere herein. In some instances, the lingual auxiliary 408 may provide less resistance to removal and/or placement compared to the lingual auxiliary 404 of FIG. 4A, which may be beneficial, e.g., in situations where higher retention forces are not needed.

Although FIGS. 4A and 4B illustrates dental auxiliaries configured similarly to the embodiments of FIGS. 3A, 3B, and 3D, a tooth can alternatively or additionally include dental auxiliaries according to any of the other embodiments described herein, such as the embodiments of FIGS. 3C, 3E, and 3F. Moreover, although FIGS. 4A and 4B depict the lingual auxiliary and buccal auxiliary as having different shapes, in other embodiments, the lingual auxiliary and buccal auxiliary can have the same or similar shapes (e.g., both auxiliaries can have a partial ellipsoidal shape, a beveled shape, etc.). The shapes of any of the dental auxiliaries described herein may be varied as needed, e.g., to provide an optimal tradeoff between retention and ease of placement and/or removal based on the particular patient.

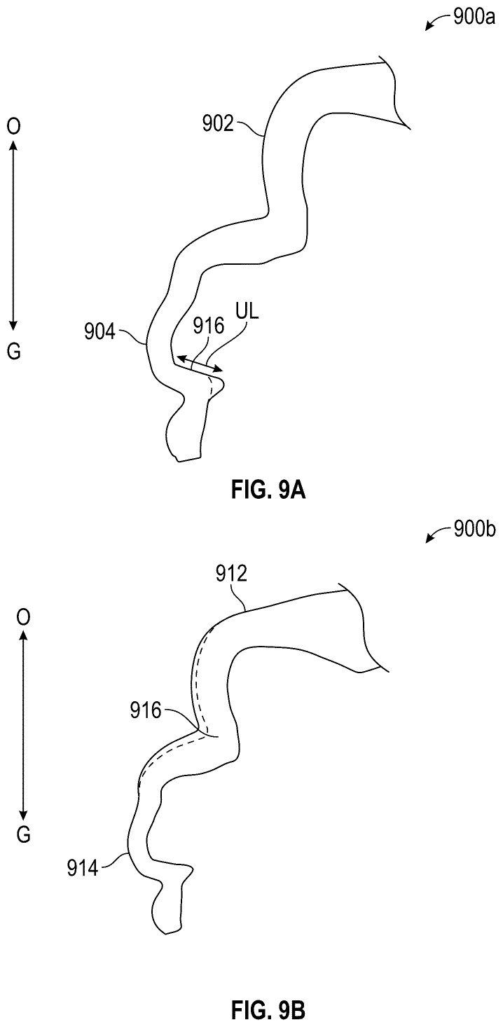

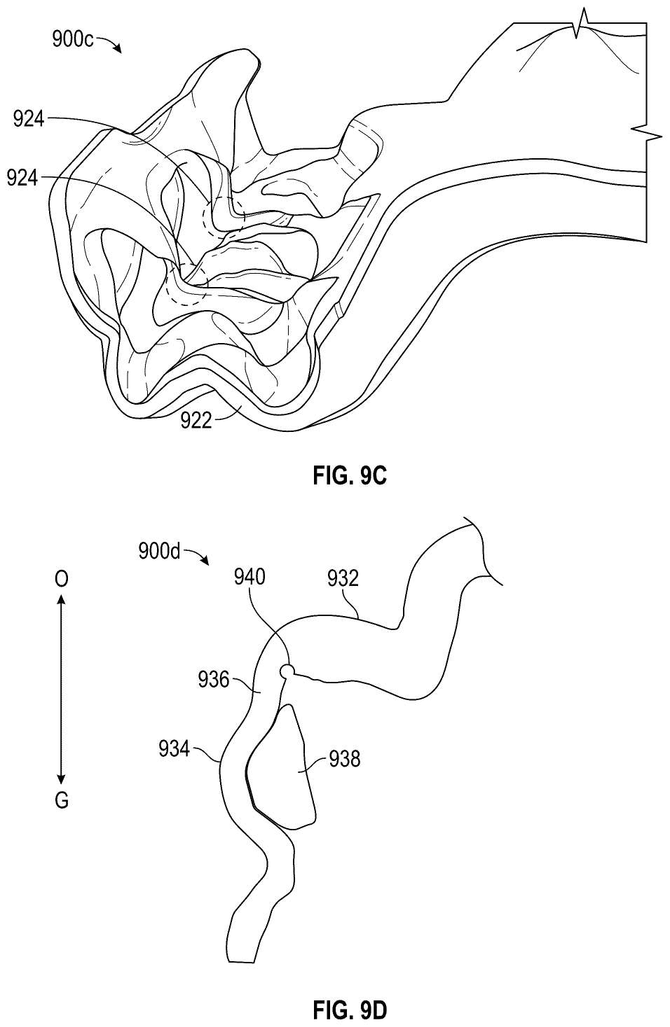

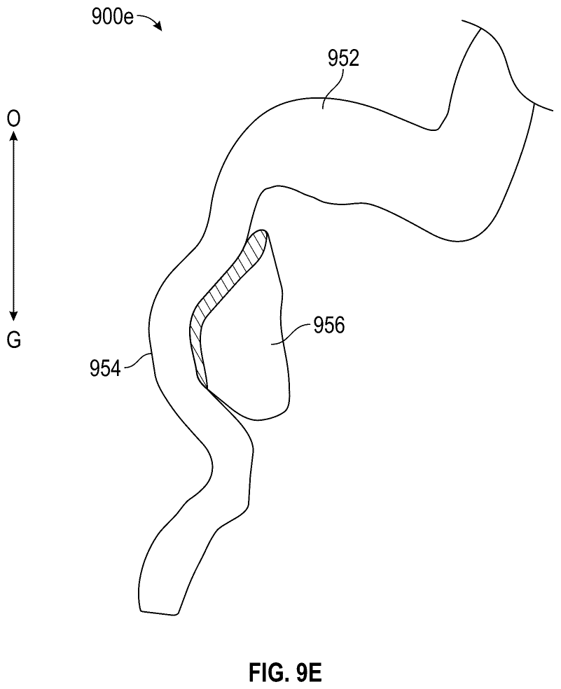

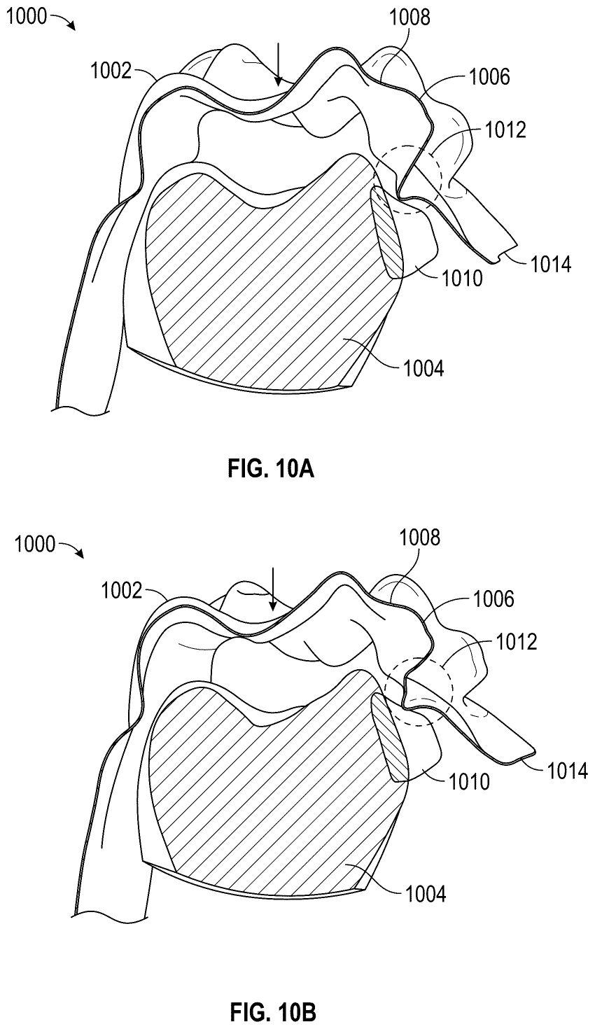

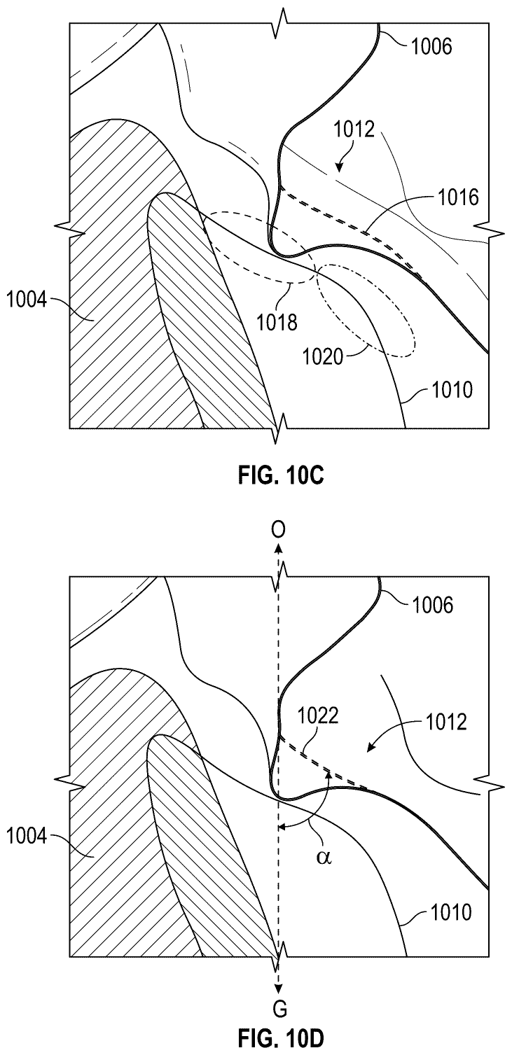

Furthermore, although the above discussion of FIGS. 3A-4B focuses on features of dental auxiliaries that are configured to facilitate placement and/or removal of a palatal expander, the features of the palatal expander itself can alternatively or additionally be configured to facilitate placement and/or removal. For instance, the surfaces of the palatal expander that come into contact with or are proximate to the dental auxiliary during placement and/or removal can be designed to reduce interference with the dental auxiliary, such as by reducing the amount of contact between the auxiliary and the palatal expander and/or by reducing an amount of deformation of the palatal expander needed to slide the palatal expander on and/or off the dental auxiliary. In some embodiments, the surfaces of the palatal expander that come into contact with or are proximate to the dental auxiliary are smoothed, rounded, and/or sloped in a direction that is aligned with (e.g., parallel to) the direction of placement and/or removal. Additional examples of palatal expander features that can be used to facilitate placement and/or removal are described, e.g., in connection with FIGS. 9A-10D below.

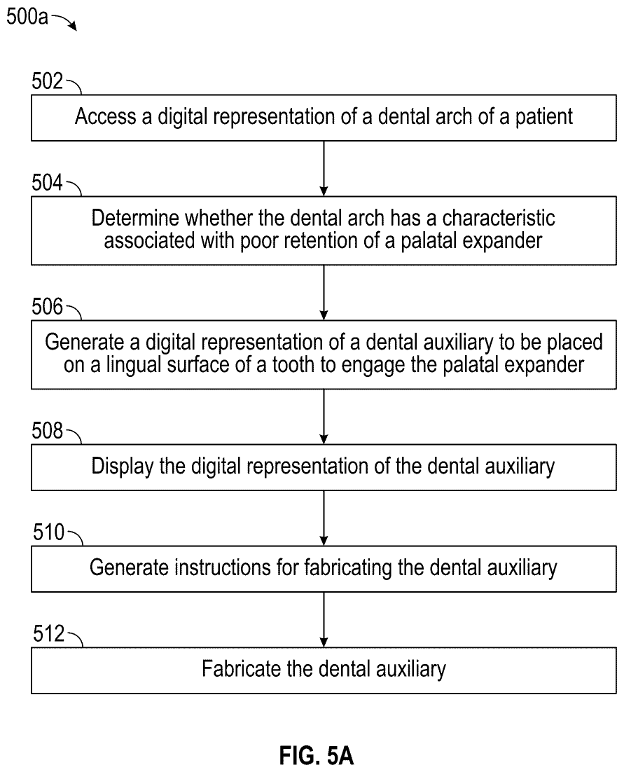

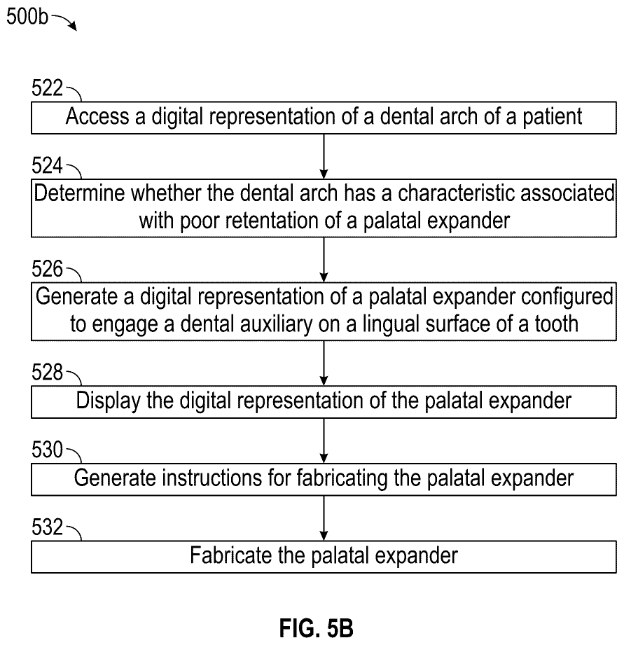

FIG. 5A is a flow diagram illustrating a method 500a for designing a dental system for expanding a patient's palate, in accordance with embodiments of the present technology. The method 500a can be used, for example, to design a dental system including one or more dental auxiliaries to retain a palatal expander on the patient's teeth, such as any of the embodiments of FIGS. 1A-4B. Some or all of the processes of the method 500a can be implemented as computer-readable instructions (e.g., program code) that are configured to be executed by one or more processors of at least one computing device (e.g., a remote server, a local client device, and/or a controller of a fabrication system).

The method 500a can begin at block 502 with accessing a digital representation of a dental arch of a patient. The digital representation can be, for example, a 2D image or a 3D model representing all or a subset of the teeth of the dental arch. Optionally, the digital representation can represent other tissues of and/or proximate to the dental arch, such as the gingiva, palate (e.g., hard and/or soft palate), jaw, etc. The digital representation can depict the patient's dental arch at any stage of treatment, such as a pre-treatment stage (e.g., before any palatal expanders and/or other dental appliances have been applied to the dental arch) or an intermediate treatment stage (e.g., after one or more palatal expanders and/or other dental appliances have been applied to the dental arch). The digital representation can be generated based on any suitable data type, such as photographs and/or videos (as captured on, e.g., a mobile computing device such as a smartphone, or another suitable device with a camera), scan data (e.g., intraoral and/or extraoral scans), MRI data, and/or radiographic data (e.g., standard x-ray data such as bitewing x-ray data, panoramic x-ray data, cephalometric x-ray data, CT data, CBCT data, fluoroscopy data).

At block 504, the method 500a can include determining whether the dental arch has a characteristic associated with poor retention of a palatal expander. The characteristic can include anatomical parameters, such as buccally-inclined teeth, short crowns, and/or a short palate depth. In some embodiments, the determination of block 504 is performed based on the digital representation of the dental arch, e.g., a software algorithm can measure the tooth inclination, crown height, and/or palate depth using the digital representation. The software algorithm can compare these measurements to threshold values to automatically evaluate whether slippage of the palatal expander is likely to occur, and/or can display the measurements to a user (e.g., a clinician or technician) for the user to evaluate whether slippage is likely. Alternatively or in combination, the digital representation can be displayed to the user and the user can determine whether characteristics indicative of poor retention are present.

In some embodiments, the process of block 504 involves predicting a retention force for the palatal expander, and comparing the predicted retention force to a threshold value. The retention force can be the sum of the forces that retain the palatal expander in its fully seated position with the dental auxiliaries engaged, and may correspond, for example, to the minimum amount of force needed to remove the palatal expander from the teeth and/or to disengage the palatal expander from the dental auxiliaries. The prediction can be performed, for example, using a simulation (e.g., a simulation performed using a physics-based model such as a finite element method (FEM) model or reduced-order FEM model), a trained machine learning model, based on comparison to experimental and/or historical data, etc. The dental arch can be considered to have poor retention characteristics if the predicted retention force is below the threshold value, such as a value less than 20 N, 15 N, 10 N, 5 N, 2 N, or 1 N.

Alternatively or in combination, the process of block 504 can involve using a simulation (e.g., a full FEM simulation or a reduced order FEM simulation) to predict the expansion forces produced by the palatal expander when the palatal expander is allowed to slip along the teeth. Slipping of the palatal expander can cause the expansion forces to drop below their intended values. The dental arch can be considered to have poor retention characteristics if the predicted expansion force with slippage is below a threshold value for effective palatal expansion (e.g., less than 50 N, 40 N, 30 N, or 20 N). Optionally, the simulation can be used to predict the expansion forces produced by the palatal expander when the expander is not allowed to slip, and the expansion forces without slippage can be compared to the expansion forces with slippage. In such embodiments, the dental arch can be considered to have poor retention characteristics if the predicted expansion forces with slippage are significantly lower than the predicted expansion forces without slippage (e.g., at least 10%, 20%, 30%, 40%, 50%, 60%, 70%, 80%, or 90% lower).

At block 506, if the characteristic associated with poor retention is present, the method 500a can continue with generating a digital representation of a dental auxiliary to be placed on a lingual surface of a tooth to engage the palatal expander. As described herein, the lingual dental auxiliary can be configured to facilitate retention of the palatal expander on the dental arch. Optionally, the shape, dimensions, position, and/or orientation of the lingual dental auxiliary can also be configured to allow for easy placement of the palatal expander on the dental arch and/or easy removal of the palatal expander from the dental arch. The lingual dental auxiliary can have any of the features described herein, e.g., in connection with the embodiments FIGS. 3A-4B. For instance, the lingual dental auxiliary can have an occlusally-oriented surface and/or a gingivally-oriented surface that is rounded, angled, beveled, or otherwise designed to reduce placement and/or removal forces, respectively, as disclosed herein.

The digital representation of the dental auxiliary can be provided in any suitable digital data format, such as one or more 2D images, 3D models, etc. The digital representation can be generated using any suitable technique, such as simulations (e.g., simulations performed using physics-based models such as FEM models or reduced-order FEM models), trained machine learning models, optimization algorithms (e.g., topological optimization algorithms), selection from a library of predetermined dental auxiliary designs, modification of a predetermined dental auxiliary design, based on user input, etc. Optionally, the generation of the digital representation can be an iterative process in which an initial design for the dental auxiliary is produced, evaluated (e.g., to assess retention forces, placement forces, removal forces, and/or expansion forces), and modified as appropriate until a satisfactory design is achieved (e.g., a design that provides sufficiently high retention forces, sufficiently low placement forces, sufficiently low removal forces, and/or sufficiently high expansion forces). The modifications can include, for example, changing the dimensions of the initial design (e.g., length, width, prominence), changing the shape of the initial design (e.g., smoothing, rounding, angling, beveling, etc., of the gingivally-oriented and/or occlusally-oriented surfaces), changing the position and/or orientation of the initial design, etc.

Optionally, the process of block 506 can involve generating digital representations of a plurality of dental auxiliaries, at least some or all of which are lingual dental auxiliaries. For example, the process of block 506 can include generating a digital representation of at least one second dental auxiliary, which can include another dental auxiliary to be placed on the same tooth and/or another dental auxiliary to be placed on a different tooth. The number, geometry, and arrangement of the dental auxiliaries can be varied and/or iterated until a satisfactory design is achieved (e.g., the dental auxiliaries produce sufficiently high retention forces, sufficiently low placement forces, and/or sufficiently low removal forces).

At block 508, the method 500a can include displaying the digital representation of the dental auxiliary. The digital representation can be displayed to a user via any suitable output device, such as a screen, monitor, etc., of a computing device (e.g., a mobile device such as a smartphone or tablet, a personal computer, a laptop, a workstation). In some embodiments, the processes of blocks 502, 504, 506, and 508 are performed by the same computing device, such as a local client device. Alternatively, the processes of blocks 502, 504, and 506 can be performed by a first computing device (e.g., a remote server) and the process of block 508 can be performed by a second computing device (e.g., a local client device in communication with the remote server). In such embodiments, rather than displaying the digital representation, the method 500a can include transmitting the digital representation to an output device of the second computing device for display.

At block 510, the method 500a can include generating instructions for fabricating the dental auxiliary, based on the digital representation of the dental auxiliary. The dental auxiliary may be fabricated as a standalone component, or may be fabricated as part of a larger device. For example, the dental auxiliary can be fabricated as part of a dental auxiliary positioner that, when worn on the patient's teeth, places the dental auxiliary at the appropriate location on the tooth. In some embodiments, the dental auxiliary positioner includes a registration element configured to receive the tooth, and an auxiliary support coupled to the registration element and temporarily coupled to the dental auxiliary (e.g., via breakable elements such as one or more struts) to position the dental auxiliary against the tooth.

The instructions can be any digital data set suitable for controlling the operation of a fabrication system to be used to produce the dental auxiliary (and, optionally, a dental auxiliary positioner including the dental auxiliary). In some embodiments, for example, the fabrication system is an additive manufacturing system including an energy source (e.g., a laser or light engine) configured to apply energy to a precursor material (e.g., a polymeric powder or resin) to form the dental auxiliary in a layer-by-layer manner. In such embodiments, the instructions can be configured to control the energy produced by the energy source to form the dental auxiliary from a plurality of layers of the precursor material according to the geometry specified in the digital representation of the dental auxiliary. The instructions can be provided in any suitable format, such as a toolpath file format (e.g., G-code file format).

At block 512, the method 500a can include fabricating the dental auxiliary Fabrication of the dental auxiliary (and, optionally, a dental auxiliary positioner including the dental auxiliary) can be performed using any suitable technique, such an additive manufacturing process. Examples of additive manufacturing processes include, but are not limited to, the following: (1) vat photopolymerization and similar processes in which an object is constructed from a vat or other bulk source of liquid resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, the dental auxiliary (and/or dental auxiliary positioner) can be fabricated using a combination of two or more additive manufacturing processes.

In some embodiments, the process of block 512 is performed by a fabrication system (e.g., an additive manufacturing system) and the processes of blocks 502, 504, 506, and 510 are performed by a computing device (e.g., a local client device or a remote server). Accordingly, the method 500a can include transmitting the instructions generated in the process of block 510 to the fabrication system to control the fabrication process of block 512. In some embodiments, the method 500a includes transmitting the digital representation of the dental auxiliary generated in block 506 to the fabrication system, and the fabrication system can generate instructions and perform the fabrication according to the processes of blocks 510 and 512, respectively.

The method 500a illustrated in FIG. 5A can be modified in many different ways. For example, some of the processes of the method 500a can be omitted, such as the processes of blocks 502, 508, 510, and/or 512. The method 500a can include additional processes not shown in FIG. 5A. For example, the method 500a can further include generating a digital representation of a corresponding palatal expander that engages the dental auxiliary, displaying the digital representation of the palatal expander (e.g., together with or separately from the digital representation of the dental auxiliary), generating instructions for fabricating the palatal expander, and/or fabricating the palatal expander, e.g., as discussed below in connection with FIG. 5B. Moreover, the order of the processes shown in FIG. 5A can be varied as desired. Furthermore, although the above processes of the method 500a are described with respect to a single lingual auxiliary on a single tooth, the method 500a can be used to generate multiple lingual auxiliaries for multiple teeth, and/or can be used to generate auxiliaries on other surfaces of the teeth (e.g., buccal auxiliaries).

FIG. 5B is a flow diagram illustrating a method 500b for designing a dental system for expanding a patient's palate, in accordance with embodiments of the present technology. The method 500b can be used, for example, to design a dental system including a palatal expander that engages one or more dental auxiliaries on the patient's teeth, such as any of the embodiments of FIGS. 1A-4B. Some or all of the processes of the method 500b can be implemented as computer-readable instructions (e.g., program code) that are configured to be executed by one or more processors of at least one computing device (e.g., a remote server, a local client device, and/or a controller of a fabrication system). Moreover, the method 500b can be performed in combination with any of the other methods described herein, such as the method 500a of FIG. 5A.

The method 500b can begin at block 522 with accessing a digital representation of a dental arch of a patient. The process of block 522 can be identical or generally similar to the process of block 502 of the method 500a of FIG. 5A.

At block 524, the method 500b can include determining whether the dental arch has a characteristic associated with poor retention of a palatal expander. The process of block 524 can be identical or generally similar to the process of block 504 of the method 500a of FIG. 5A.

At block 526, if the characteristic associated with poor retention is present, the method 500b can continue with generating a digital representation of a palatal expander configured to engage a dental auxiliary on a lingual surface of a tooth to engage the palatal expander. The palatal expander can have any of the features described herein, e.g., in connection with the embodiments of FIGS. 1A-2. For example, the palatal expander can include first and second tooth engagement portions that are each configured to receive a respective set of teeth on opposite sides of the dental arch, and a palatal portion between the first and second tooth engagement portions. The palatal expander can further include a receptacle formed therein (e.g., in a lingual surface of the first tooth engagement portion or the second tooth engagement portion) to receive the lingual dental auxiliary. As previously discussed in connection with block 506 of the method 500a of FIG. 5A, the lingual dental auxiliary can be configured to facilitate retention of the palatal expander on the dental arch, and can also be configured to allow for easy placement and/or removal of the palatal expander. The lingual dental auxiliary can have any of the features described herein, e.g., in connection with the embodiments FIGS. 3A-4B.

The digital representation of the palatal expander can be provided in any suitable digital data format, such as one or more 2D images, 3D models, etc. The digital representation can be generated using any suitable technique, such as simulations (e.g., simulations performed using physics-based models such as FEM models or reduced-order FEM models), trained machine learning models, optimization algorithms (e.g., topological optimization algorithms), selection from a library of predetermined palatal expander designs, modification of a predetermined palatal expander design, based on user input, etc. Optionally, the generation of the digital representation can be an iterative process in which an initial design for the palatal expander is produced, evaluated (e.g., to assess retention forces, placement forces, removal forces, and/or expansion forces), and modified as appropriate until a satisfactory design is achieved (e.g., a design that provides sufficiently high retention forces, sufficiently low placement forces, sufficiently low removal forces, and/or sufficiently high expansion forces). The modifications can include, for example, changing the dimensions of the initial design (e.g., size of the receptacle for the lingual dental auxiliary), changing the shape of the initial design (e.g., smoothing, rounding, angling, beveling, etc., of the surfaces that contact and/or are proximate to the dental auxiliary), etc.

Optionally, the palatal expander can be configured to engage a plurality of dental auxiliaries, at least some or all of which are lingual dental auxiliaries and/or at least some of which are buccal dental auxiliaries. In such embodiments, the palatal expander can include a plurality of receptacles, each receptacle configured to receive a respective dental auxiliary. The number, geometry, and arrangement of the dental auxiliaries, as well as the geometry of the corresponding receptacles of the palatal expander, can be varied and/or iterated until a satisfactory design is achieved (e.g., the palatal expander exhibits sufficiently high retention forces, sufficiently low placement forces, and/or sufficiently low removal forces).

At block 528, the method 500b can include displaying the digital representation of the palatal expander. The digital representation can be displayed to a user via any suitable output device, such as a screen, monitor, etc., of a computing device (e.g., a mobile device such as a smartphone or tablet, a personal computer, a laptop, a workstation). In some embodiments, the processes of blocks 522, 524, 526, and 528 are performed by the same computing device, such as a local client device. Alternatively, the processes of blocks 522, 524, and 526 can be performed by a first computing device (e.g., a remote server) and the process of block 528 can be performed by a second computing device (e.g., a local client device in communication with the remote server). In such embodiments, rather than displaying the digital representation, the method 500b can include transmitting the digital representation to an output device of the second computing device for display.

At block 530, the method 500b can include generating instructions for fabricating the palatal expander, based on the digital representation of the palatal expander. The instructions can be any digital data set suitable for controlling the operation of a fabrication system to be used to produce the palatal expander. In some embodiments, for example, the fabrication system is an additive manufacturing system including an energy source (e.g., a laser or light engine) configured to apply energy to a precursor material (e.g., a polymeric powder or resin) to form the palatal expander in a layer-by-layer manner. In such embodiments, the instructions can be configured to control the energy produced by the energy source to form the palatal expander from a plurality of layers of the precursor material according to the geometry specified in the digital representation of the palatal expander. The instructions can be provided in any suitable format, such as a toolpath file format (e.g., G-code file format).

At block 532, the method 500b can include fabricating the palatal expander Fabrication of the palatal expander can be performed using any suitable technique, such an additive manufacturing process, e.g., as previously described in connection with block 510 of the method 500a of FIG. 5A. Alternatively, the palatal expander can be fabricated using other types of manufacturing processes, such as a thermoforming process.

In some embodiments, the process of block 532 is performed by a fabrication system (e.g., an additive manufacturing system) and the processes of blocks 522, 524, 526, and 530 are performed by a computing device (e.g., a local client device or a remote server). Accordingly, the method 500b can include transmitting the instructions generated in the process of block 530 to the fabrication system to control the fabrication process of block 532. In some embodiments, the method 500b includes transmitting the digital representation of the palatal expander generated in block 526 to the fabrication system, and the fabrication system can generate instructions and perform the fabrication according to the processes of blocks 530 and 532, respectively.

The method 500b illustrated in FIG. 5B can be modified in many different ways. For example, some of the processes of the method 500b can be omitted, such as the processes of blocks 522, 528, 530, and/or 532. The method 500b can include additional processes not shown in FIG. 5B. For example, the method 500b can further include generating a digital representation of a dental auxiliary to be used with the palatal expander, displaying the digital representation of the dental auxiliary (e.g., together with or separately from the digital representation of the palatal expander), generating instructions for fabricating the dental auxiliary, and/or fabricating the dental auxiliary, e.g., as discussed above in connection with FIG. 5A. Moreover, the order of the processes shown in FIG. 5B can be varied as desired. Furthermore, although the above processes of the method 500b are described with respect to a single palatal expander that engages a single lingual auxiliary on a single tooth, the method 500b can be used to generate a palatal expander that engages multiple lingual auxiliaries for multiple teeth and/or auxiliaries on other surfaces of the teeth (e.g., buccal auxiliaries), and/or a series of palatal expanders for incrementally expanding the patient's palate in a plurality of treatment stages.

In some cases, forces that are applied to a dental auxiliary during placement of a palatal expander on the teeth and/or removal of the palatal expander from the teeth may cause the dental auxiliary to partially or fully detach from the tooth. Detachment of the dental auxiliary can interfere with the function of the palatal expander (e.g., the palatal expander may slip from the teeth and/or may not be able to apply the appropriate forces to the teeth), and may require a follow-up appointment for the patient to receive a replacement dental auxiliary. As disclosed herein, a palatal expander may be stiffer than other types of dental appliance due to the relatively large forces involved in palatal expansion, and thus may apply higher forces on the dental auxiliary during placement and/or removal of the palatal expander. For instance, contact between the palatal expander and the dental auxiliary during the placement and/or removal process can produce shear forces on the dental auxiliary. In embodiments where the dental auxiliary is bonded to the tooth using an adhesive (e.g., a light-curable adhesive), excessively high shear forces during placement and/or removal of the palatal expander may deform, fracture, or otherwise compromise the integrity of the adhesive, thereby causing de-bonding of the dental auxiliary from the tooth surface.

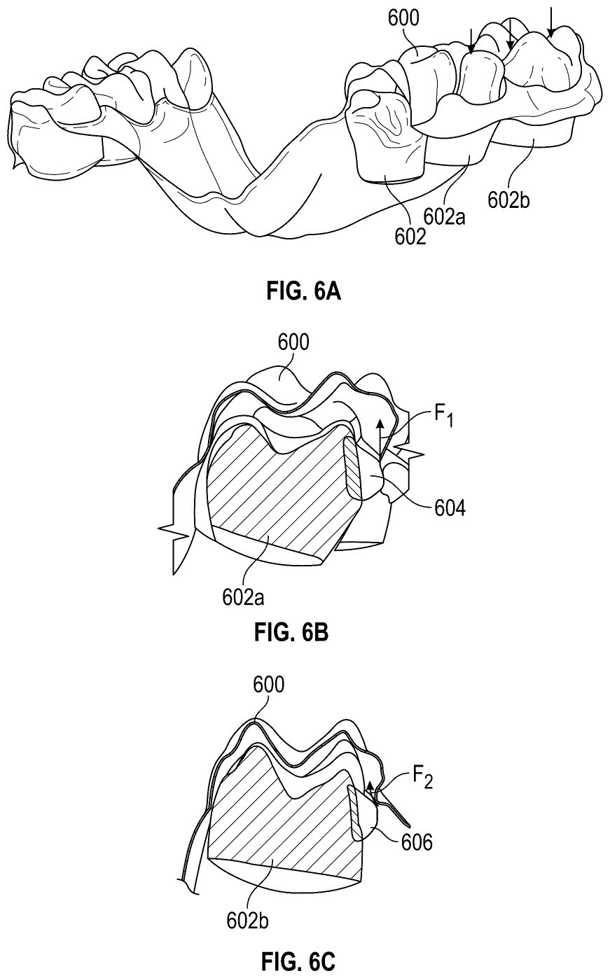

FIGS. 6A-6C illustrate simulation data of forces applied by a palatal expander 600 during placement of the palatal expander 600 on a patient's teeth. Specifically, FIG. 6A illustrates a digital representation of the palatal expander 600 together with digital representations of teeth 602 of the upper jaw (the palatal expander 600 is depicted upside down), FIG. 6B illustrates a simulated force applied by the palatal expander 600 to a first dental auxiliary 604 on a first tooth 602a as the palatal expander 600 is pushed over the first dental auxiliary 604, and FIG. 6C illustrates a simulated force applied by the palatal expander 600 to a second dental auxiliary 606 on a second tooth 602b as the palatal expander 600 is pushed over the second dental auxiliary 606.

Referring first to FIG. 6A, a simulation model was used to evaluate the peak shear forces applied to each dental auxiliary on the teeth 602 during placement and removal of the palatal expander 600. The maximum shear forces may occur during the placement process (the placement direction is indicated by the downward arrows in FIG. 6A). In some instances, dental auxiliaries bonded to different teeth 602 may experience different shear forces, e.g., there may be significant discrepancies in the forces applied to dental auxiliaries on different teeth. As an example, the peak shear force F₁ applied to the first dental auxiliary 604 on the first tooth 602a was 59.2 N (FIG. 6B), while the peak shear force applied to the second dental auxiliary 606 on the second tooth 602b neighboring the first tooth 602a was only 5.5 N (FIG. 6C). The high simulated shear forces on the first dental auxiliary 604 may indicate that the first dental auxiliary 604 is at risk of detaching during placement of the palatal expander 600. The risk of detachment can be lowered, for example, by modifying the design of the palatal expander 600, the first dental auxiliary 604, and/or the second dental auxiliary 606 to reduce the peak shear force F₁ applied to the first dental auxiliary 604 and/or to balance the applied forces across the first dental auxiliary 604 and the second dental auxiliary 606 (e.g., reducing the force discrepancy between the first dental auxiliary 604 and the second dental auxiliary 606).

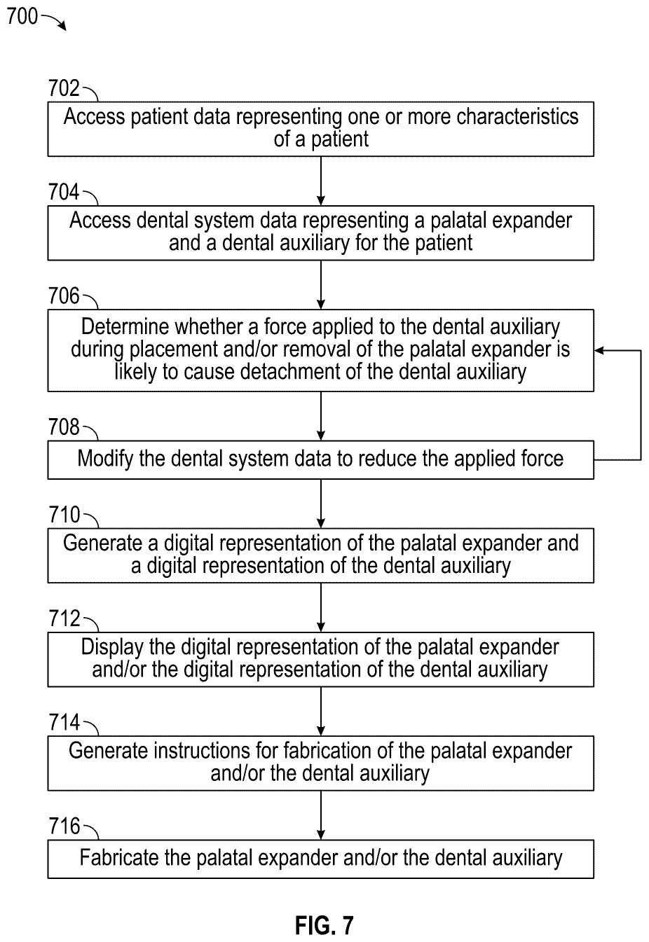

FIG. 7 is a flow diagram illustrating a method 700 for designing a dental system for expanding a patient's palate, in accordance with embodiments of the present technology. The method 700 can be used, for example, to design a dental system including a palatal expander that engages one or more dental auxiliaries on the patient's teeth. Some or all of the processes of the method 700 can be implemented as computer-readable instructions (e.g., program code) that are configured to be executed by one or more processors of at least one computing device (e.g., a remote server, a local client device, and/or a controller of a fabrication system). Moreover, the method 700 can be performed in combination with any of the other methods described herein, such as the method 500a of FIG. 5A and/or the method 500b of FIG. 5B.

The method 700 can begin at block 702 with accessing patient data representing one or more characteristics of the patient. The patient data can include any information relevant to patient treatment, such as anatomical characteristics (e.g., characteristics of a dental arch of the patient, such as crown height, tooth angulation, tooth rotation, tooth inclination angles, tooth surface normal directions, arch width, arch form, palate depth, etc.), demographic information (e.g., race, gender, age), and/or treatment information (e.g., medication, patient compliance, disease history, or treatment history). In some embodiments, the patient data provides information relevant to assessing the risk of dental auxiliary detachment during placement and/or removal of the palatal expander. For instance, certain anatomical characteristics may be associated with higher detachment rates; boys may have a higher detachment risk than girls due to differences in bite forces; individuals in different age groups may exhibit different degrees of compliance with the instructions for proper placement and removal; patients with periodontal disease may have a lower detachment risk due to decreased moduli of the periodontal ligaments; patients who have had previous incidence of auxiliary detachment during treatment may be more likely to have future incidences of detachment; etc.

At block 704, the method 700 can continue with accessing dental system data representing a palatal expander and a dental auxiliary for the patient. The dental auxiliary can be configured to be coupled to a tooth in order to engage and retain the palatal expander on a dental arch of the patient as disclosed herein, e.g., in connection with FIGS. 1A-4B. The dental system data can include a digital representation of the palatal expander and/or a digital representation of dental auxiliary, such as one or more 3D models, 2D images, etc. The digital representations can be generated using any suitable technique, such as simulations, trained machine learning models, optimization algorithms, selection from a library of predetermined designs, modification of a predetermined design, based on user input, etc.

Alternatively or in combination, the dental system data can include parameters representing the design of the palatal expander and/or the dental auxiliary. For instance, the dental system data can include one or more palatal expander parameters representing the geometry of the palatal expander (e.g., shape, dimensions) and/or the material properties of the palatal expander (e.g., stiffness, Young's modulus, stress relaxation behavior); and/or one or more dental auxiliary parameters representing the geometry of the dental auxiliary (e.g., shape, dimensions), location of the dental auxiliary (e.g., position, orientation) and/or material properties of the dental auxiliary (e.g., bonding strength). In some embodiments, the dental system data includes any of the following parameters: thickness of the palatal expander, stiffness of the palatal expander, slope of the dental auxiliary, prominence of the dental auxiliary, width of the dental auxiliary, length of the dental auxiliary, position of the dental auxiliary, and/or orientation of the dental auxiliary.

Optionally, the dental system data of block 704 can represent a plurality of dental auxiliaries. For example, the dental system data can include a digital representation of and/or dental auxiliary parameters for at least one second dental auxiliary, which can include another dental auxiliary to be placed on the same tooth and/or another dental auxiliary to be placed on a different tooth. Some or all of the dental auxiliaries can be configured for placement on a buccal surface of a tooth, or some or all of the dental auxiliaries can be configured for placement on a different surface of a tooth, such as a lingual surface or an occlusal surface. In some embodiments, one or more lingual dental auxiliaries can be used to enhance retention of the palatal expander, e.g., as discussed above in connection with FIGS. 2-5B.

At block 706, the method 700 can include determining whether a force applied to the dental auxiliary during placement and/or removal of the palatal expander is likely to cause detachment of the dental auxiliary from the tooth. The applied force can include, for example, a peak shear force that is applied to the dental auxiliary by the palatal expander during placement of the palatal expander on the patient's dental arch and/or removal of the palatal expander from the dental arch. As described herein, shear forces and/or other forces may result from contact between the relatively stiff palatal expander and the dental auxiliary, and may result in de-bonding of the dental auxiliary if the forces exceed the strength of the adhesive used to mount the dental auxiliary to the tooth.

The determination of block 706 can be performed in many different ways. For example, the determination can be performed by predicting whether the force applied to the dental auxiliary during placement and/or removal will exceed a threshold value, such as a threshold value of 100 N, 125 N, 150 N, 175 N, or 200 N. As another example, the determination can be performed by predicting whether there will be a discrepancy in the force applied to the dental auxiliary and a force applied to a dental auxiliary on another tooth (e.g., a neighboring tooth) or to a dental auxiliary on another surface of the same tooth. A large force discrepancy (e.g., greater than 1.5×, 2×, 5×, 10×, 15×, 20×, or 50×) may indicate that one of the dental auxiliaries will be subjected to excessively high forces. In a further example, the determination can be performed by predicting a likelihood that the dental auxiliary will be detached from the tooth during placement and/or removal of the palatal expander. The likelihood may be expressed quantitatively (e.g., x % probability of detachment) and/or qualitatively (e.g., as a binary categorization (such as “yes” or “no”) or other classification (such as “highly likely,” “likely,” “unlikely,” “highly unlikely”)).

The determination of block 706 can be based on the patient data of block 702 and/or the dental system data of block 704. In some embodiments, the patient data and/or dental system data are input into a prediction model that generates a prediction of the applied force (e.g., peak shear force), force discrepancy, and/or likelihood of detachment. Various types of prediction models can be used. For instance, the prediction model can be or include a physics-based model that simulates the forces on the dental auxiliary during the placement and/or removal process, such as a FEM model or reduced-order FEM model. In such embodiments, the prediction model can perform the simulation using digital representations of the palatal expander, dental auxiliary, and the patient's dental arch, as well as information regarding the material properties of the palatal expander and dental auxiliary (e.g., Young's modulus), environmental conditions (e.g., temperature, humidity), placement direction, removal direction, etc.

As another example, the prediction model can be or include a machine learning model that is trained to predict the applied force, force discrepancy, and/or likelihood of detachment. Examples of machine learning models that may be used to predict forces include regression models (e.g., linear regression models) and neural networks. Examples of machine learning models that may be used to predict the likelihood of detachment include regression models (e.g., logistic regression models), support vector machines, decision trees, and neural networks. The input to the machine learning model can include the patient data and the dental system data, and the output of the machine learning model can include one or more predicted force values and/or a predicted likelihood of detachment. The machine learning model can be trained on a training data set, which may include experimental data, clinical data, simulation data, or suitable combinations thereof.

In some embodiments, the prediction model used in block 706 is a reduced-order model that involves less computational complexity and computing resources than a conventional high-fidelity physics-based model (e.g., a full FEM model). The reduced-order prediction model can be a reduced-order physics-based model, such as a reduced-order FEM model in which one or more model parameters are simplified compared to a full FEM model. For example, the digital representations of the palatal expander, dental auxiliary, and/or teeth used for the FEM simulation may be simplified (e.g., represented as 2D models with 1D elements such as a series of connected beams with varying cross-sections, rather than as 3D models), the boundary conditions for the FEM simulation may be simplified (e.g., expressed as displacement or force controls), nonlinear behavior may be simplified (e.g., approximated as linear behavior), or suitable combinations thereof. As another example, the reduced-order prediction model can be a machine learning model with model parameters that are trained based on experimental data, data from a high-fidelity physics-based model (e.g., a full FEM model), etc. Optionally, the output of the reduced-order model can be post-processed to improve accuracy, e.g., by filtering, thresholding, applying calibrated corrections, etc. In some embodiments, the use of a reduced-order model can advantageously reduce computing time (e.g., compared to a full FEM simulation) while maintaining a satisfactory degree of prediction accuracy.

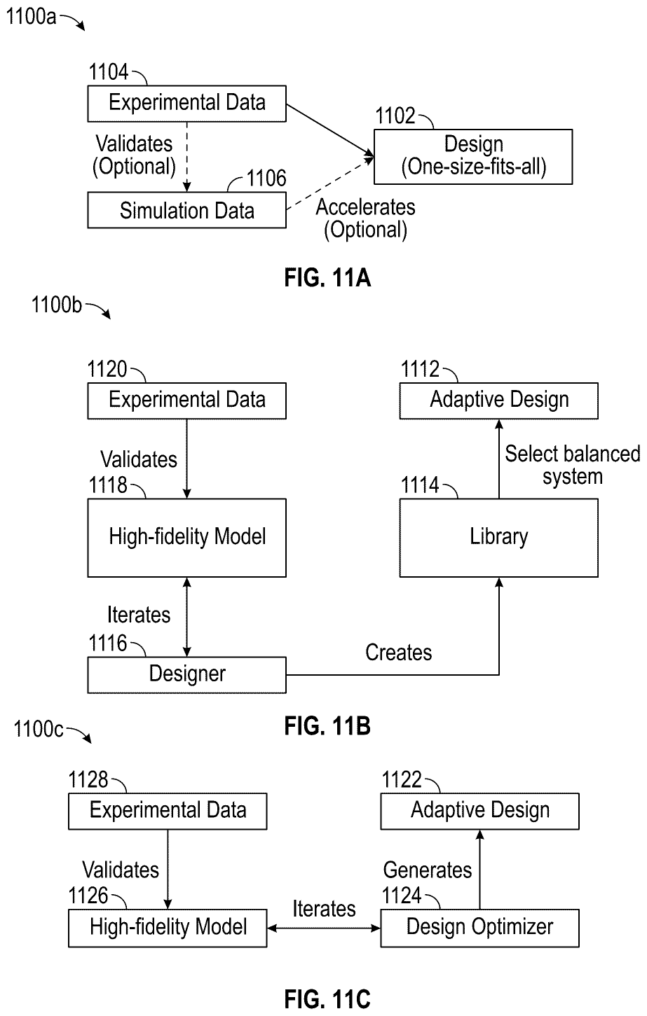

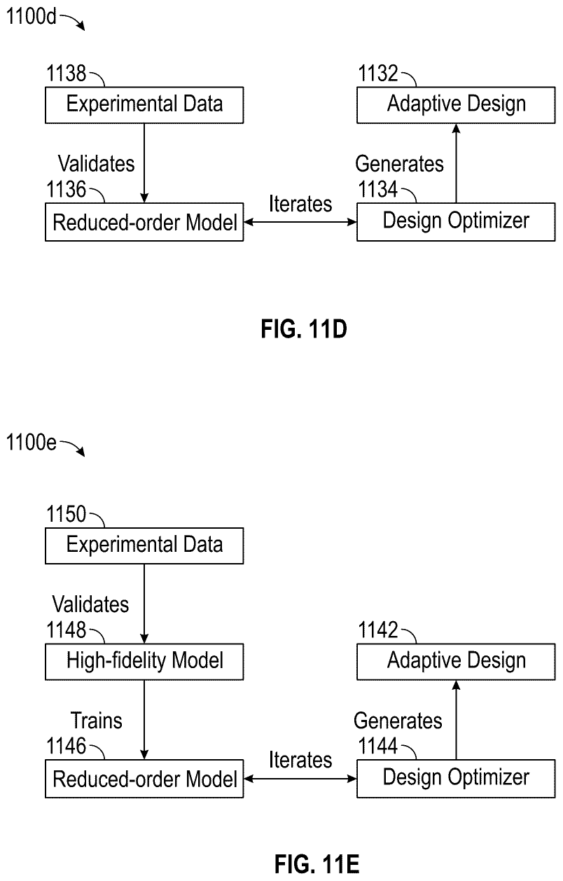

Additional details and examples of models that may be used in block 706 are discussed further below in connection with FIGS. 11A-11E.

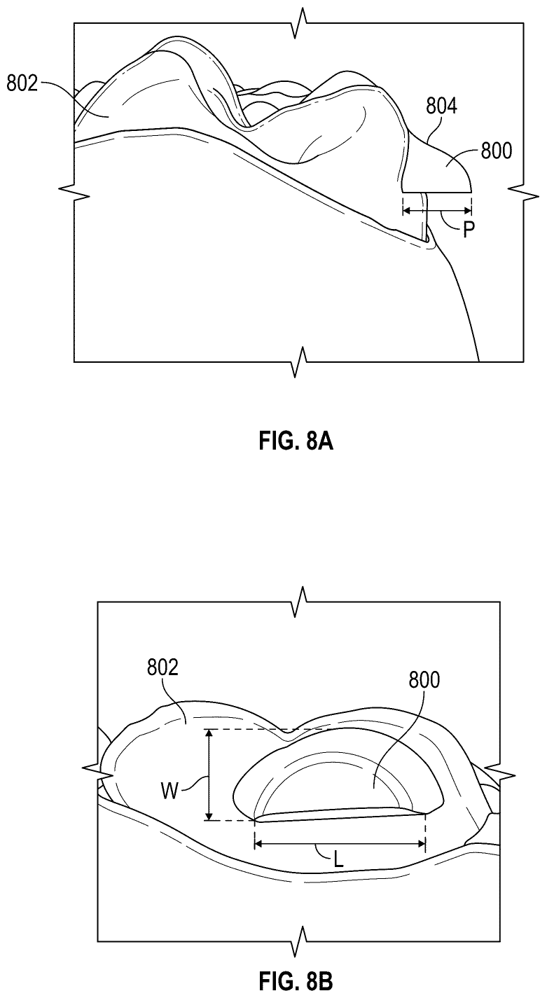

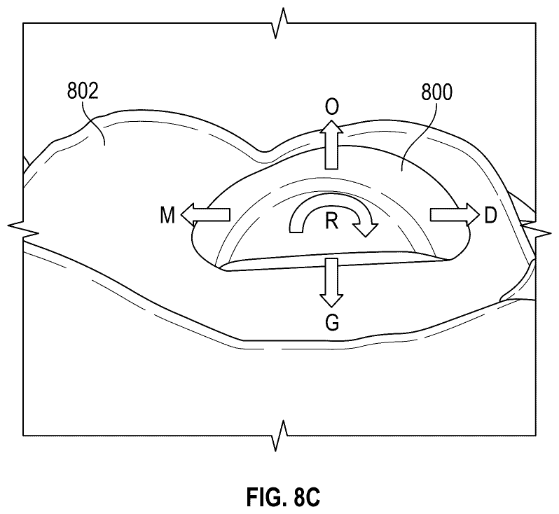

If it is determined that the applied force is likely to cause detachment of the dental auxiliary, the method 700 can continue at block 708 with modifying the dental system data to reduce the applied force. The modifications can include changing a geometry of a portion of the palatal expander, changing a stiffness of the palatal expander, changing a geometry of the dental auxiliary, changing a position of the dental auxiliary, changing an orientation of the dental auxiliary, or suitable combinations thereof. In some embodiments, the modifications are configured to reduce the stiffness of the palatal expander (e.g., at portions of the palatal expander that come into contact with or otherwise proximate to the dental auxiliary), which may reduce the forces applied to the dental auxiliary by making it easier to bend the palatal expander to fit around the dental auxiliary during placement and/or removal. Alternatively or in combination, the modification can be configured to reduce interference between the palatal expander and the dental auxiliary during placement and/or removal, such as by reducing the amount of contact between the dental auxiliary and the palatal expander and/or by reducing an amount of deformation of the palatal expander needed to fit the palatal expander over the dental auxiliary. Alternatively or in combination, the modification can be configured to reduce a discrepancy between the force applied to the dental auxiliary and a force applied to a dental auxiliary on another tooth (e.g., a neighboring tooth) or on another surface of the same tooth. In such embodiments, the modification can redistribute the forces produced by placement and/or removal of the palatal expander more evenly across multiple dental auxiliaries, which can reduce the maximum force applied to any individual dental auxiliary. Additional details and examples of modifications that can be made in the process of block 708 are described further below in connection with FIGS. 8A-10D.

In some embodiments, the modifications in block 708 are made based on the patient data of block 702 and/or the dental system data of block 704. For instance, the patient data and/or dental system data can be input into a dental system design algorithm, and the dental system design algorithm can determine modifications to the dental system data that would reduce the forces applied to the dental auxiliary during placement and/or removal. Optionally, the dental system design algorithm can also consider other factors when determining the modifications, such as ensuring that there are still sufficient retention forces to keep the palatal expander properly seated on the patient's teeth, ensuring that the palatal expander is still capable of applying the appropriate expansion forces to the teeth in accordance with the treatment plan, avoiding dental auxiliary and/or palatal expander geometries that may be challenging to fabricate, etc. The dental system design algorithm can be any software algorithm suitable for generating and/or modifying a design for a palatal expander and/or dental auxiliary, such as an optimization algorithm, a machine learning algorithm, a rule-based algorithm, and suitable combinations thereof.

In some embodiments, for example, the dental system design algorithm is an optimization algorithm. Various types of optimization algorithms can be used, such as topology optimization algorithms. In some embodiments, a topology optimization algorithm performs a shape optimization method to determine a material layout within a defined space for a given set of loads, conditions, and/or constraints. For example, the loads for the shape optimization can include predefined forces, such as the expansion forces specified by the treatment plan and the desired shear force to be applied to the dental auxiliary. The conditions and/or constraints for the shape optimization can be defined adaptively, and can include any of the parameters for the dental auxiliary and palatal expander described herein. In some embodiments, topology optimization is used to improve or maximize palatal expansion performance, reduce or minimize the shear stress on the dental auxiliary during placement and/or removal, and/or improve efficiency of the palatal expander design by removing redundant material from areas that do not need to carry significant loads to reduce appliance size and further improve patient comfort.

Additional details and examples of techniques of software algorithms that may be used in block 708 are discussed further below in connection with FIGS. 11A-11E.

The determination process of block 706 and the modification process of block 708 can be repeated to iteratively evaluate and modify the design of the palatal expander and/or the dental auxiliary until a satisfactory design is achieved, e.g., a design in which the force applied to the dental auxiliary is predicted to avoid detachment of the dental auxiliary during placement and/or removal of the palatal expander. In some embodiments, the output of the determination process of block 706 (e.g., the predicted force, force discrepancy, and/or likelihood of detachment) is used as input to the modification process of block 708 to determine the modified dental system data. Subsequently, the determination process of block 708 can be repeated to determine whether the force applied to the dental auxiliary during placement and/or removal based on the modified dental system data. Further modifications to the dental system data can be made as needed until modified dental system data that results in an applied force that is likely to avoid detachment of the dental auxiliary from the tooth is achieved.

At block 710, the method 700 can continue with generating a digital representation of the palatal expander and/or a digital representation of the dental auxiliary, based on the modified dental system data. The digital representations can depict the designs of the palatal expander and/or dental auxiliary according to the configuration specified by the modified dental system data, e.g., incorporating the modifications to the geometry, location, etc., made in the process of block 708. The digital representations can be provided in any suitable digital data format, such as 2D images, 3D models, etc.

At block 712, the method 700 can include displaying the digital representation of the palatal expander and/or the digital representation of the dental auxiliary. The digital representation(s) can be displayed to a user via any suitable output device, such as a screen, monitor, etc., of a computing device (e.g., a mobile device such as a smartphone or tablet, a personal computer, a laptop, a workstation). The digital representation of the palatal expander may be displayed together with or separately from the digital representation of the dental auxiliary. In some embodiments, the processes of blocks 702, 704, 706, 708, 710, and 712 are performed by the same computing device, such as a local client device. Alternatively, the processes of blocks 702, 704, 706, 708, and 710 can be performed by a first computing device (e.g., a remote server) and the process of block 712 can be performed by a second computing device (e.g., a local client device in communication with the remote server). In such embodiments, rather than displaying the digital representation(s), the method 700 can include transmitting the digital representation(s) to an output device of the second computing device for display.

At block 714, the method 700 can include generating instructions for fabrication of the palatal expander and/or the dental auxiliary. The instructions can be any digital data set suitable for controlling the operation of a fabrication system to be used to produce the palatal expander and/or the dental auxiliary. In some embodiments, for example, the fabrication system is an additive manufacturing system including an energy source (e.g., a laser or light engine) configured to apply energy to a precursor material (e.g., a polymeric powder or resin) to form the palatal expander and/or the dental auxiliary (and, optionally, a dental auxiliary positioner including the dental auxiliary) in a layer-by-layer manner. The instructions can be provided in any suitable format, such as a toolpath file format (e.g., G-code file format).

At block 716, the method 700 can include fabricating the palatal expander and/or the dental auxiliary. Fabrication of the palatal expander and/or the dental auxiliary (and, optionally, a dental auxiliary positioner including the dental auxiliary) can be performed using any of the techniques described herein, such as an additive manufacturing process. In some embodiments, the palatal expander is fabricated using a first type of additive manufacturing process (e.g., a powder bed fusion process such as SLS), and the dental auxiliary (and/or dental auxiliary positioner) is fabricated using a second, different type of additive manufacturing process (e.g., a vat photopolymerization process such as SLA or DLP).

The method 700 illustrated in FIG. 7 can be modified in many different ways. For example, some of the processes of the method 700 can be omitted, such as the processes of blocks 712, 714, and/or 716. The method 700 can include additional processes not shown in FIG. 7, and/or the order of the processes shown in FIG. 7 can be varied as desired. Furthermore, although the above processes of the method 700 are described with respect to a single palatal expander and a single dental auxiliary, the method 700 can be used to generate a palatal expander that engages multiple auxiliaries for multiple teeth, and/or a series of palatal expanders for incrementally expanding the patient's palate in a plurality of treatment stages.

FIGS. 8A-10D illustrate examples of modifications that may be made to a dental system, in accordance with embodiments of the present technology. Specifically, FIGS. 8A-8C illustrate modifications to a dental auxiliary, and FIGS. 9A-10D illustrate modifications to a palatal expander. The modifications shown in FIGS. 8A-10D may be used to reduce the likelihood of dental auxiliary detachment, and may be implemented by the modification process of block 708 of the method 700 of FIG. 7, for example. Any of the modifications shown in FIGS. 8A-10D may be combined with each other and/or may be applied to any embodiment of the palatal expanders and dental auxiliaries described herein, such as the embodiments of FIGS. 1A-4B.

FIG. 8A is a side view of a dental auxiliary 800 on a tooth 802, and FIGS. 8B and 8C are front views of the dental auxiliary 800 on the tooth 802, in accordance with embodiments of the present technology. Referring first to FIG. 8A, the dental auxiliary 800 can have a prominence P corresponding to the maximum or average height of the dental auxiliary 800 above the surface of the tooth 802. In some embodiments, the prominence P can be modified to reduce the forces applied to the dental auxiliary 800 during placement and/or removal of a palatal expander, e.g., a smaller prominence P may be associated with smaller forces on the dental auxiliary 800.

In some embodiments, the dental auxiliary 800 includes an angled surface 804, which may also affect the forces applied to the dental auxiliary 800. In the illustrated embodiment, for example, the angled surface 804 is an occlusally-oriented surface, which may affect forces applied to the dental auxiliary 800 during placement of the palatal expander, as disclosed elsewhere herein. Alternatively or in combination, the dental auxiliary 800 may include an angled gingivally-oriented surface, which may affect forces applied to the dental auxiliary 800 during removal of the palatal expander, as disclosed elsewhere herein. In some embodiments, the applied forces may be reduced by altering the slope of the angled surface 804 to be more aligned with (e.g., parallel to) the direction of placement and/or removal (e.g., the gingival-occlusal axis).

Referring next to FIG. 8B, the dental auxiliary 800 can have a length L and a width W. The length L can correspond to the maximum or average horizontal dimension of the dental auxiliary 800 (e.g., along a mesial-distal direction), and the width W can correspond to the maximum or average vertical dimension of the dental auxiliary 800 (e.g., along a gingival-occlusal direction). In some embodiments, the length L and/or the width W can each independently be modified to reduce the forces applied to the dental auxiliary 800 during placement and/or removal of the palatal expander.

Referring next to FIG. 8C, other modifications that may be made to the dental auxiliary 800 include changing a position of the dental auxiliary 800 on the tooth 802, such by moving the dental auxiliary 800 relative to the tooth 802 in a mesial direction M, a distal direction D, a gingival direction G, and/or in an occlusal direction O. Alternatively or in combination, the modifications can include changing an orientation of the dental auxiliary 800 on the tooth 802, such as by rotating the dental auxiliary 800 in a rotation direction R or in the opposite direction of the rotation direction R.

FIG. 9A is a side cross-sectional view of a portion of a palatal expander 900a configured in accordance with embodiments of the present technology. The palatal expander 900a includes a tooth engagement portion 902 configured to receive a tooth, and a receptacle 904 formed in a sidewall of the tooth engagement portion 902 to receive a dental auxiliary on the tooth. The receptacle 904 includes an undercut surface 906 that is proximate to the gingival end of the received dental auxiliary. In some embodiments, the length of the undercut surface 906 (“undercut length UL”) affects the forces applied to the dental auxiliary during placement and/or removal of the palatal expander 900a, e.g., a longer undercut length UL may increase the amount of bending of the palatal expander 900a needed to fit around the dental auxiliary during placement and/or removal, and thus may increase the applied force. Accordingly, to reduce the applied force, the undercut surface 906 can be modified to reduce the undercut length UL, e.g., as indicated by the broken lines in FIG. 9A.

FIG. 9B is a side cross-sectional view of a portion of a palatal expander 900b configured in accordance with embodiments of the present technology. The palatal expander 900b includes a tooth engagement portion 912 configured to receive a tooth, and a receptacle 914 formed in a sidewall 916 of the tooth engagement portion 912 to receive a dental auxiliary on the tooth. In some embodiments, the thickness of the portion of the sidewall 916 that is proximate to the occlusal end of the receptacle 914 affects the forces applied to the dental auxiliary during placement and/or removal of the palatal expander 900b, e.g., a thicker sidewall 916 may be stiffer and thus may increase the amount of force needed to bend the palatal expander 900b to fit around the dental auxiliary during placement and/or removal, which may increase the applied force on the dental auxiliary. Accordingly, to reduce the applied force, the thickness of the portion of the sidewall 916 proximate to the occlusal end of the receptacle 914 can be reduced, e.g., as indicated by the broken lines in FIG. 9B.

FIG. 9C is a perspective view of a portion of a palatal expander 900c configured in accordance with embodiments of the present technology. The palatal expander 900c includes a tooth engagement portion 922 configured to receive a set of teeth, and at least one receptacle formed in the tooth engagement portion 922 to receive a dental auxiliary on the teeth (the receptacle is obscured in FIG. 9C). In some embodiments, the tooth engagement portion 922 includes one or more interproximal regions 924 that are positioned near the interproximal portions of the received teeth when the palatal expander 900c is worn. The amount of material at the interproximal regions 924 can affect the forces applied to the dental auxiliary during placement and/or removal of the palatal expander 900c, e.g., more material at the interproximal regions 924 can stiffen the palatal expander 900c and thus may increase the amount of force needed to bend the palatal expander 900c to fit around the dental auxiliary during placement and/or removal, which may increase the applied force on the dental auxiliary. Accordingly, to reduce the applied force, at least some of the material at the interproximal regions 924 can be removed to increase the flexibility of the tooth engagement portion 922.

FIG. 9D is a side cross-sectional view of a portion of a palatal expander 900d configured in accordance with embodiments of the present technology. The palatal expander 900d includes a tooth engagement portion 932 configured to receive a tooth, and a receptacle 934 formed in a sidewall 936 of the tooth engagement portion 932 to receive a dental auxiliary 938 on the tooth. In the illustrated embodiments, a groove 940 (e.g., a perforation, score, channel, recess, etc.) is formed in an interior surface of the sidewall 936 at a location proximate to the occlusal end of the receptacle 934. The presence of the groove 940 can serve as a hinge feature that makes it easier to bend the sidewall 936 around the dental auxiliary 938 during placement and/or removal of the palatal expander 900d, and thus can be added to the palatal expander 900d to reduce the force applied to the dental auxiliary 938 during placement and/or removal.

FIG. 9E is a side cross-sectional view of a portion of a palatal expander 900e configured in accordance with embodiments of the present technology. The palatal expander 900e includes a tooth engagement portion 952 configured to receive a tooth, and a receptacle 954 formed in a sidewall of the tooth engagement portion 952 to receive a dental auxiliary 956 on the tooth. In some situations, the actual size and/or prominence of the dental auxiliary 956 on the tooth may be larger than the intended size and/or prominence of the dental auxiliary 956 (e.g., as indicated by the hatched region in FIG. 9E). This phenomenon may occur, for example, due to inaccuracies during manufacturing (e.g., overcuring of the material used to form the dental auxiliary 956 during additive manufacturing) and/or inaccuracies when bonding the dental auxiliary 956 on the tooth. The larger size and/or prominence may result in increased interference between the dental auxiliary 956 and the palatal expander 900e during placement and/or removal of the palatal expander 900e, which may increase the forces applied on the dental auxiliary 956. Accordingly, the geometry of the receptacle 954 can be modified to provide a clearance space (e.g., a gap) between the interior surface of the receptacle 954 and the exterior surface of the dental auxiliary 956, which can mitigate interference issues even if the actual dental auxiliary 956 is larger and/or more prominent than intended. In some embodiments, the clearance space is located adjacent to non-working surfaces of the receptacle 954, e.g., portions of the interior surface of the receptacle 954 that are not intended to directly contact or otherwise engage the dental auxiliary 956 when the palatal expander 900e is worn on the tooth.

FIGS. 10A-10D illustrate modifications to a palatal expander 1000, in accordance with embodiments of the present technology. Specifically, FIG. 10A is a cross-sectional view of a portion of the palatal expander 1000 with an initial design, FIG. 10B is a cross-sectional view of the portion of the palatal expander 1000 with a modified design, and FIGS. 10C and 10D are closeup views of the modified portion of the palatal expander 1000.

Referring first to FIG. 10A, the palatal expander 1000 includes a tooth engagement portion 1002 configured to receive a tooth 1004, and a receptacle 1006 formed in a sidewall 1008 of the tooth engagement portion 1002 to receive a dental auxiliary 1010 on the tooth 1004. The sidewall 1008 includes an undercut region 1012 located between the gingival end of the receptacle 1006 and the gingival edge 1014 of the tooth engagement portion 1002. As shown in FIG. 10A, during placement of the palatal expander 1000 on the tooth 1004, the undercut region 1012 may contact the occlusally-oriented surface of the dental auxiliary 1010, which can produce forces on the dental auxiliary 1010 that may cause the dental auxiliary 1010 to detach from the tooth 1004 if these forces are not accounted for as described herein.

FIG. 10B illustrates the palatal expander 1000 with modifications to the receptacle 1006 and undercut region 1012. Specifically, the receptacle 1006 can be modified so there is more space between the undercut region 1012 and the gingiva of the tooth 1004. In some embodiments, the increased space allows for changes to the shape of the interior surface of the undercut region 1012 to reduce forces applied to the dental auxiliary 1010 during placement and/or removal of the palatal expander 1000.

Referencing FIG. 10C, in some embodiments, the shape of the undercut region 1012 can be adjusted so that the location where the palatal expander 1000 first comes into contact with the occlusally-oriented surface of the dental auxiliary 1010 during placement of the palatal expander 1000 is shifted outward away from the surface of the tooth 1004 and toward the most prominent point of the dental auxiliary 1010. In the illustrated embodiment, for instance, the inner surface of the undercut region 1012 can be adjusted (e.g., smoothed as indicated by curve 1016 in FIG. 10C) to shift the initial contact location buccally outward from a first region 1018 to a second region 1020. This modification can reduce the extent of deformation of the palatal expander 1000 needed to fit the palatal expander 1000 over the dental auxiliary 1010, thereby reducing the forces applied to the dental auxiliary 1010 during the placement process.

As another example, as shown in FIG. 10D, the shape of the undercut region 1012 can be adjusted (e.g., smoothed as indicated by curve 1022 in FIG. 10D) so that the angle between the interior surface of the undercut region 1012 (e.g., angle α) and the placement direction of the palatal expander 1000 (e.g., downward along the occlusal-gingival axis) is minimized. For example, the angle can be less than or equal to 20°, 15°, 10°, 5°, 2°, or 1°, or can be 0°. This modification can reduce interference between the dental auxiliary 1010 and the palatal expander 1000 during the placement process, thereby reducing the forces applied to the dental auxiliary 1010.

Other modifications that may be made to a palatal expander of the present technology, alternatively or in addition to the modifications shown in FIGS. 9A-10D, include any of the following: changing the shape and/or height of the buccal sidewall of the palatal expander, changing the shape and/or angle of the transition from the buccal sidewall to the gingival edge of the palatal expander, changing the shape of the occlusal ridge line of the palatal expander, and/or extending the length of the gingival edge of the palatal expander to serve as a handle to provide leverage for placement and/or removal of the palatal expander.

FIGS. 11A-11E illustrate example workflows for designing a dental system, in accordance with embodiments of the present technology. The embodiments shown in FIGS. 11A-11E may be used in connection with the method 700 of FIG. 7, for example, and may be used to generate and/or modify designs for any of the palatal expanders and dental auxiliaries described herein.

FIG. 11A is a flow diagram illustrating a workflow 1100a for designing a dental system, in accordance with embodiments of the present technology. The workflow 1100a includes generating a design 1102 for a dental system (e.g., a palatal expander and/or at least one dental auxiliary) based on experimental data 1104 and, optionally, simulation data 1106. The design 1102 can be configured to reduce the likelihood of dental auxiliary detachment during placement and/or removal of the palatal expander, as described elsewhere herein.

In the illustrated embodiment, the design 1102 is not customized to the particular characteristics of the patient, and is instead a generic design that may be used for multiple patients (e.g., a “one-size-fits-all” design). Optionally, certain aspects of the design 1102 may be customized to the patient (e.g., the locations of the dental auxiliaries and the geometry of the tooth engagement portions of the palatal expander can be adapted to the patient's tooth arrangement), while other aspects of the design 1102 are generic across all patients (e.g., the shape of the dental auxiliaries and corresponding receptacles on the palatal expanders can be generic).

The experimental data 1104 can include data characterizing the forces, detachment rates, ease of placement/removal, etc., associated with various palatal expander and/or dental auxiliary designs, and can include benchtop testing data and/or clinical data from actual patient cases. Accordingly, the experimental data 1104 can be used to identify palatal expander and/or dental auxiliary designs that are likely to avoid excessive forces on the dental auxiliary during palatal expander placement and/or removal.

The simulation data 1106 can include data generated from physics-based simulations (e.g., FEM simulations) to predict the forces associated with various palatal expander and/or dental auxiliary designs. The simulation data 1106 can also be used to identify palatal expander and/or dental auxiliary designs that are likely to be successful in avoiding excessive forces on the dental auxiliary during palatal expander placement and/or removal. Optionally, some or all of the simulation data 1106 may be validated using the experimental data 1104 to ensure accuracy. The use of simulation data 1106 may accelerate the process of determining the optimal palatal expander and/or dental auxiliary designs for avoiding dental auxiliary detachment, since the simulation data 1106 may be generated more quickly and easily than the experimental data 1104.

FIG. 11B is a flow diagram illustrating a workflow 1100b for designing a dental system, in accordance with embodiments of the present technology. The workflow 1100b includes generating an adaptive design 1112 for a dental system (e.g., a palatal expander and/or at least one dental auxiliary) using a library 1114. The adaptive design 1112 can be configured to reduce the likelihood of dental auxiliary detachment during placement and/or removal of the palatal expander, as described elsewhere herein.

In the illustrated embodiment, the library 1114 is used to select an adaptive design 1112 for a palatal expander and/or dental auxiliary that is customized to the particular patient. For instance, the library 1114 can be a regression data library that determines dental system data representing a palatal expander and/or dental auxiliary design (e.g., geometry, location, material properties) that is optimal for a given set of patient data (e.g., anatomy, demographics, treatment history, treatment prescription, etc., representing patient-specific characteristics) using regression techniques.

In some embodiments, some or all of the data in the library 1114 is created using a designer 1116 and a high-fidelity model 1118. The high-fidelity model 1118 (e.g., a high-fidelity physics-based model such as a FEM model) can perform simulations to determine the relationship between patient data and dental system data that produces successful outcomes, e.g., palatal expander and/or dental auxiliary designs that are likely to avoid excessive forces on the dental auxiliary for a particular patient's characteristics. The parameters of the high-fidelity model 1116 can optionally be validated using experimental data 1120 (e.g., benchtop testing data and/or clinical data) to ensure model accuracy. The designer 1116 can be a human user and/or a software algorithm (e.g., a trained machine learning model) that uses the high-fidelity model 1118 to evaluate a plurality of different palatal expander and/or dental auxiliary designs. For instance, the designer 1116 can iterate through different parameters for the dental system data (e.g., shape, slope, location, orientation, thicknesses) to generate different designs for the palatal expander and/or dental auxiliary, and can use the simulation results from high-fidelity model 1118 to identify designs that are optimal or otherwise produce successful outcomes for different patient cases. The data for the identified designs can be stored in the library 1114. In some embodiments, some or all of these processes are performed in a “pre-production” phase before submission of a patient case, such that the library 1114 includes a plurality of predetermined palatal expander and/or dental auxiliary designs that have already been validated using the designer 1116 and the high-fidelity model 1118. Subsequently, when a patient case is submitted during the “production” phase, the library 1114 can be searched to select a particular predetermined design that is optimal or otherwise advantageous for that particular patient (e.g., a dental system that produces balanced forces across multiple dental auxiliaries). This approach can result in a faster and more streamlined process during the production phase, while also providing designs that achieve successful outcomes for diverse patient cases.

FIG. 11C is a flow diagram illustrating a workflow 1100c for designing a dental system, in accordance with embodiments of the present technology. The workflow 1100c includes generating an adaptive design 1122 for a dental system (e.g., a palatal expander and/or at least one dental auxiliary) using a design optimization algorithm (“design optimizer 1124”). The adaptive design 1122 can be configured to reduce the likelihood of dental auxiliary detachment during placement and/or removal of the palatal expander, as described elsewhere herein.

In the illustrated embodiment, the design optimizer 1124 is used to generate an adaptive design 1122 for a palatal expander and/or dental auxiliary that is customized to the particular patient. For instance, the input to the design optimizer 1124 can include patient data representing relevant characteristics of the patient (e.g., anatomy, demographics, treatment history, treatment prescription), and the output of the design optimizer 1124 can include dental system data representing characteristics of a palatal expander and/or dental auxiliary for the patient (e.g., geometry, locations, material properties). In some embodiments, the design optimizer 1124 uses an optimization algorithm to generate the dental system data, such as a topology optimization algorithm as previously discussed herein.

The dental system data produced by the design optimizer 1124 can be provided to a high-fidelity model 1126 (e.g., a high-fidelity physics-based model such as a full FEM model) that performs simulations to evaluate whether the palatal expander and/or dental auxiliary design meets certain criteria, such as whether the forces applied to the dental auxiliary during placement and/or removal of the palatal expander are likely to cause detachment. The input to the high-fidelity model 1126 can also include the patient data so that the simulations take patient-specific characteristics into account (e.g., the anatomy of the patient's dental arch). The parameters of the high-fidelity model 1126 can optionally be validated using experimental data 1128 (e.g., benchtop testing data and/or clinical data) to ensure model accuracy.

If the simulation results indicate that the design does not meet the criteria (e.g., dental auxiliary detachment is likely to occur), the design optimizer 1124 can modify the dental system data, such as by changing the geometry, location, properties, etc., of the palatal expander and/or dental auxiliary, as described elsewhere herein. The processes of evaluating and modifying the palatal expander and/or dental auxiliary design can be iterated until a satisfactory design is achieved (e.g., a design that is likely to avoid dental auxiliary detachment during placement and/or removal of the palatal expander).

FIG. 11D is a flow diagram illustrating a workflow 1100d for designing a dental system, in accordance with embodiments of the present technology. The workflow 1100d includes generating an adaptive design 1132 for a dental system (e.g., a palatal expander and/or at least one dental auxiliary) using a design optimization algorithm (“design optimizer 1134”). The adaptive design 1132 can be configured to reduce the likelihood of dental auxiliary detachment during placement and/or removal of the palatal expander, as described elsewhere herein.

The design optimizer 1134 can be identical or generally similar to the design optimizer 1124 of the workflow 1100c of FIG. 11C. For example, the design optimizer 1134 can be configured to generate an adaptive design 1132 for a palatal expander and/or dental auxiliary that is customized to the particular patient, e.g., using an optimization algorithm. The input to the design optimizer 1134 can include patient data representing relevant characteristics of the patient, and the output of the design optimizer 1134 can include dental system data representing characteristics of a palatal expander and/or dental auxiliary for the patient.

The dental system data produced by the design optimizer 1134 can be provided to a reduced-order model 1136 that evaluates whether the palatal expander and/or dental auxiliary design meets certain criteria, such as whether the forces applied to the dental auxiliary during placement and/or removal of the palatal expander are likely to cause detachment. The input to the reduced-order model 1136 can also include the patient data so that the evaluation takes patient-specific characteristics into account (e.g., the anatomy of the patient's dental arch). In some embodiments, the reduced-order model 1136 is a reduced-order physics-based model that performs simulations using simplified parameters, as described herein. In such embodiments, the parameters for the reduced-order physics-based model can be validated using experimental data 1138 (e.g., benchtop testing data and/or clinical data) to ensure model accuracy. In some embodiments, the reduced-order model 1136 is a machine learning model that is trained on experimental data 1138 to predict the performance of a palatal expander and/or dental auxiliary design, as described herein.

If the results of the evaluation performed by the reduced-order model 1136 indicate that the design does not meet the criteria (e.g., dental auxiliary detachment is likely to occur), the design optimizer 1134 can modify the dental system data, such as by changing the geometry, location, properties, etc., of the palatal expander and/or dental auxiliary, as described elsewhere herein. The processes of evaluating and modifying the palatal expander and/or dental auxiliary design can be iterated until a satisfactory design is achieved (e.g., a design that is likely to avoid dental auxiliary detachment during placement and/or removal of the palatal expander).

FIG. 11E is a flow diagram illustrating a workflow 1100e for designing a dental system, in accordance with embodiments of the present technology. The workflow 1100e includes generating an adaptive design 1142 for a dental system (e.g., a palatal expander and/or at least one dental auxiliary) using a design optimization algorithm (“design optimizer 1144”). The adaptive design 1142 can be configured to reduce the likelihood of dental auxiliary detachment during placement and/or removal of the palatal expander, as described elsewhere herein.

The design optimizer 1144 can be identical or generally similar to the design optimizer 1124 of the workflow 1100c of FIG. 11C. For example, the design optimizer 1144 can be configured to generate an adaptive design 1142 for a palatal expander and/or dental auxiliary that is customized to the particular patient, e.g., using an optimization algorithm. The input to the design optimizer 1144 can include patient data representing relevant characteristics of the patient, and the output of the design optimizer 1144 can include dental system data representing characteristics of a palatal expander and/or dental auxiliary for the patient.

The dental system data produced by the design optimizer 1144 and the patient data can be provided to a reduced-order model 1146, which may be identical or similar to the reduced-order model 1136 of the workflow 1100d of FIG. 11D. For example, the reduced-order model 1146 can be a reduced-order physics-based model or a machine learning model that evaluates whether the palatal expander and/or dental auxiliary design meets certain criteria, such as whether the forces applied to the dental auxiliary during placement and/or removal of the palatal expander are likely to cause detachment. If the results of the evaluation performed by the reduced-order model 1146 indicate that the design does not meet the criteria (e.g., dental auxiliary detachment is likely to occur), the design optimizer 1144 can modify the dental system data, such as by changing the geometry, location, properties, etc., of the palatal expander and/or dental auxiliary, as described elsewhere herein. The processes of evaluating and modifying the palatal expander and/or dental auxiliary design can be iterated until a satisfactory design is achieved (e.g., a design that is likely to avoid dental auxiliary detachment during placement and/or removal of the palatal expander).

In the illustrated embodiment, the parameters of the reduced-order model 1146 are trained or otherwise determined based on data generated by a high-fidelity model 1148. For instance, the high-fidelity model 1148 can be a high-fidelity physics-based model (e.g., a full FEM model) that performs simulations for multiple palatal expander and/or dental auxiliary designs to generate a data set for training a machine learning model and/or validating a reduced-order physics-based model. The parameters of the high-fidelity model 1148 can optionally be validated using experimental data 1150 (e.g., benchtop testing data and/or clinical data). This approach can improve the accuracy of the reduced-order model 1146, while also avoiding the slower computational speeds associated with using a high-fidelity model to determine an adaptive design 1142 for each patient case during production.

### II. Dental Appliances and Associated Methods

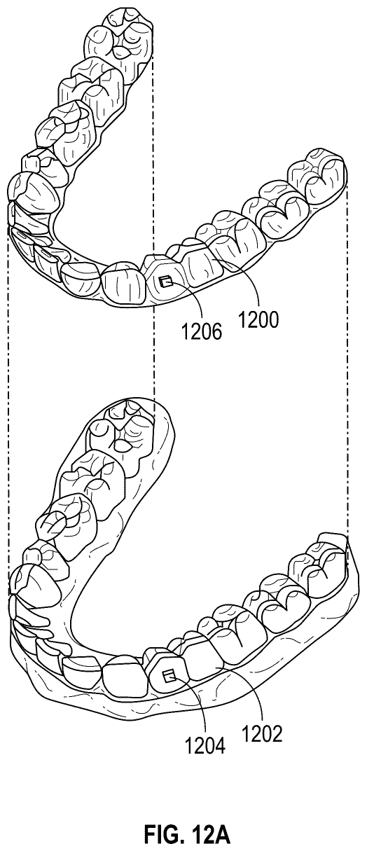

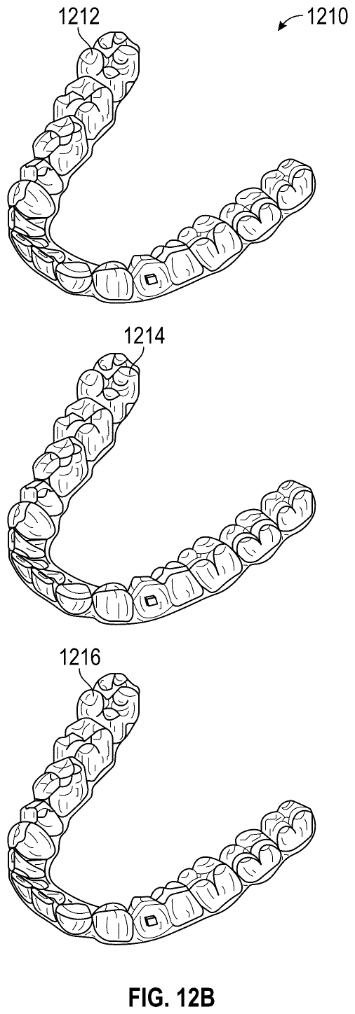

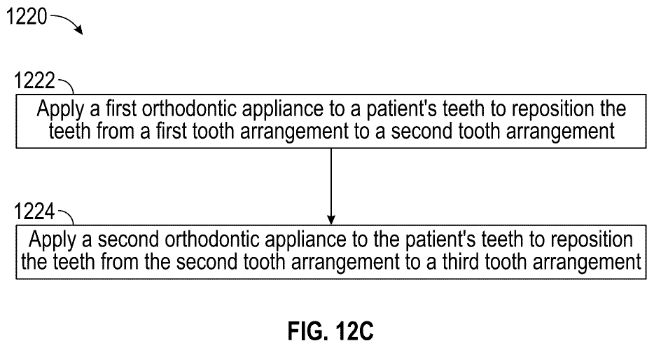

FIG. 12A illustrates a representative example of a tooth repositioning appliance 1200 configured in accordance with embodiments of the present technology. The appliance 1200 can be used in combination with any of the systems, methods, and devices described herein. The appliance 1200 (also referred to herein as an “aligner”) can be worn by a patient in order to achieve an incremental repositioning of individual teeth 1202 in the jaw. The appliance 1200 can include a shell (e.g., a continuous polymeric shell or a segmented shell) having teeth-receiving cavities that receive and resiliently reposition the teeth. The appliance 1200 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1200 can fit over all teeth present in an upper or lower jaw, or less than all of the teeth. The appliance 1200 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1200 can be a generic appliance configured to receive the teeth, but not necessarily shaped to match the topography of the patient's teeth. In some cases, only certain teeth received by the appliance 1200 are repositioned by the appliance 1200 while other teeth can provide a base or mounting region for holding the appliance 1200 in place as it applies force against the tooth or teeth targeted for repositioning. In some cases, some, most, or even all of the teeth can be repositioned at some point during treatment. Teeth that are moved can also serve as a base or mounting region for holding the appliance as it is worn by the patient. In preferred embodiments, no wires or other means are provided for holding the appliance 1200 in place over the teeth. In some cases, however, it may be desirable or necessary to provide individual attachments 1204 or other auxiliaries (e.g., buttons) on teeth 1202 with corresponding receptacles 1206 or apertures in the appliance 1200 so that the appliance 1200 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 12B illustrates a tooth repositioning system 1210 including a plurality of appliances 1212, 1214, 1216, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1210 can include a first appliance 1212 corresponding to an initial tooth arrangement, one or more intermediate appliances 1214 corresponding to one or more intermediate arrangements, and a final appliance 1216 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 12C illustrates a method 1220 of orthodontic treatment using a plurality of appliances, in accordance with embodiments of the present technology. The method 1220 can be practiced using any of the appliances or appliance sets described herein. In block 1222, a first orthodontic appliance is applied to a patient's teeth in order to reposition the teeth from a first tooth arrangement to a second tooth arrangement. In block 1224, a second orthodontic appliance is applied to the patient's teeth in order to reposition the teeth from the second tooth arrangement to a third tooth arrangement. The method 1220 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

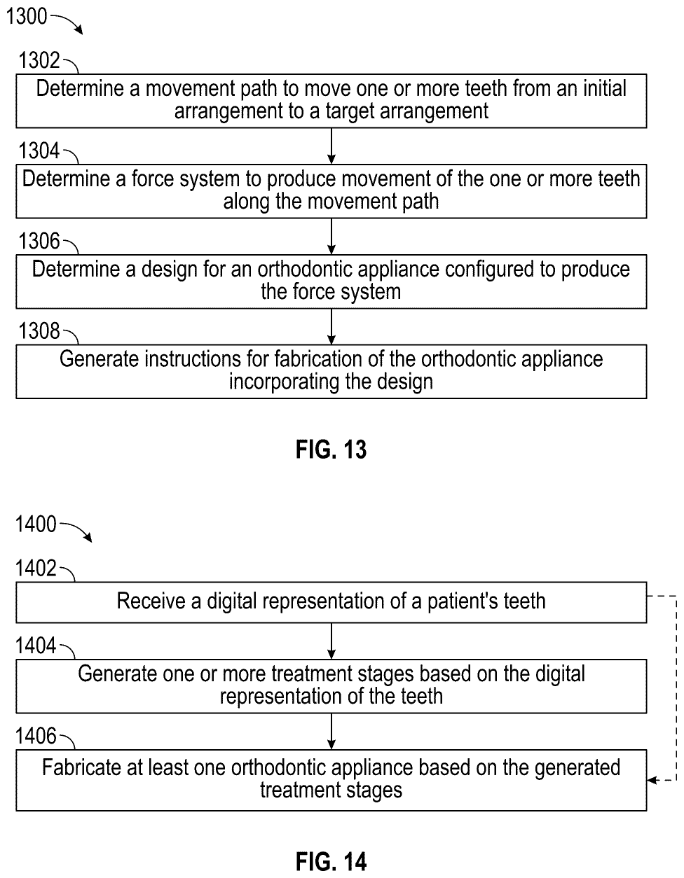

FIG. 13 illustrates a method 1300 for designing an orthodontic appliance, in accordance with embodiments of the present technology. The method 1300 can be applied to any embodiment of the orthodontic appliances described herein. Some or all of the steps of the method 1300 can be performed by any suitable data processing system or device, e.g., one or more processors configured with suitable instructions.

In block 1302, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1304, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1304 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1306, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1308, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1300 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1300 may be performed with any suitable fabrication system or device, such as the embodiments described herein. Some of the steps may be optional, e.g., the process of block 1304 can be omitted, such that the orthodontic appliance is designed based on the desired tooth movements and/or determined tooth movement path, rather than based on a force system. Moreover, the order of the steps can be varied as desired.

FIG. 14 illustrates a method 1400 for digitally planning an orthodontic treatment and/or design or fabrication of an appliance, in accordance with embodiments. The method 1400 can be applied to any of the treatment procedures described herein and can be performed by any suitable data processing system.

In block 1402, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1404, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1406, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 14, design and/or fabrication of an orthodontic appliance, and perhaps a particular orthodontic treatment, may include use of a representation of the patient's teeth (e.g., including receiving a digital representation of the patient's teeth (block 1402)), followed by design and/or fabrication of an orthodontic appliance based on a representation of the patient's teeth in the arrangement represented by the received representation.

The embodiments herein can be used in combination with aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

As described above, the embodiments herein can be used in combination with dental auxiliary positioners, e.g., devices used to position prefabricated attachments and/or other auxiliaries on a person's teeth in accordance with one or more aspects of a treatment plan. Examples of dental auxiliary positioners (also known as “attachment placement devices,” “attachment placement templates,” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The embodiments herein can be used in combination with incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

Example 1. A system for expanding a palate of a patient, the system comprising:
a palatal expander comprising:
   a first tooth engagement portion configured to receive one or more first teeth at a first side of a dental arch of the patient,
   a second tooth engagement portion configured to receive one or more second teeth at a second side of the dental arch of the patient, and
   a palatal portion between the first and second tooth engagement portions, wherein the palatal portion is configured to apply forces to the first and second tooth engagement portions to expand the palate of the patient; and
a dental auxiliary configured to be coupled to a lingual surface of a tooth of the patient, wherein the dental auxiliary is configured to engage the first tooth engagement portion or the second tooth engagement portion to facilitate retention of the palatal expander on the dental arch.

Example 2. The system of Example 1, wherein the dental auxiliary comprises an attachment.

Example 3. The system of Example 1 or 2, wherein the dental auxiliary comprises an occlusally-oriented surface having a shape configured to reduce a force associated with placement of the palatal expander on the dental arch.

Example 4. The system of Example 3, wherein the occlusally-oriented surface is rounded.

Example 5. The system of Example 3 or 4, wherein the occlusally-oriented surface is sloped in a gingival direction.

Example 6. The system of any one of Examples 1 to 5, wherein the dental auxiliary comprises a gingivally-oriented surface having a shape configured to reduce a force associated with removal of the palatal expander from the dental arch.

Example 7. The system of Example 6, wherein the gingivally-oriented surface is rounded.

Example 8. The system of Example 6 or 7, wherein the gingivally-oriented surface is sloped in an occlusal direction.

Example 9. The system of any one of Examples 1 to 8, wherein the dental auxiliary has a partial ellipsoid shape.

Example 10. The system of any one of Examples 1 to 9, wherein the palatal expander comprises a receptacle formed in the first tooth engagement portion or the second tooth engagement portion to receive the dental auxiliary.

Example 11. The system of any one of Examples 1 to 10, wherein the dental auxiliary is a first dental auxiliary, and the system further comprises a second dental auxiliary configured to engage the first tooth engagement portion or the second tooth engagement portion to facilitate retention of the palatal expander on the dental arch.

Example 12. The system of Example 11, wherein the second dental auxiliary is configured to be coupled to a buccal surface of a tooth of the patient.

Example 13. The system of Example 12, wherein the first dental auxiliary and the second dental auxiliary are configured to be coupled to the same tooth.

Example 14. The system of Example 12, wherein the first dental auxiliary and the second dental auxiliary are configured to be coupled to different teeth.

Example 15. The system of Example 11, wherein the second dental auxiliary is configured to be coupled to a lingual surface of a different tooth of the patient.

Example 16. The system of any one of Examples 1 to 15, further comprising:
a set of first dental auxiliaries configured to be coupled to the one or more first teeth and to engage the first tooth engagement portion, and
a set of second dental auxiliaries configured to be coupled to the one or more second teeth and to engage the second tooth engagement portion,
wherein the set of first dental auxiliaries or the set of second dental auxiliaries comprises the dental auxiliary.

Example 17. The system of any one of Examples 1 to 16, wherein the palatal expander is a first palatal expander, and the system further comprises a second palatal expander comprising:
a first tooth engagement portion configured to receive the one or more first teeth,
a second tooth engagement portion configured to receive the one or more second teeth, and
a palatal portion between the first and second tooth engagement portions,
wherein the palatal portion of the second palatal expander has a different geometry than the palatal portion of the first palatal expander, and
wherein the dental auxiliary is configured to engage the first or second tooth engagement portion of the second palatal expander to facilitate retention of the second palatal expander on the dental arch.

Example 18. A dental auxiliary for engaging a palatal expander on a patient's teeth, the dental auxiliary comprising:
a first surface configured to be coupled to a lingual surface of a tooth of the patient; and
a second surface configured to engage a portion of the palatal expander to facilitate retention of the palatal expander on the patient's teeth.

Example 19. The dental auxiliary of Example 18, wherein the dental auxiliary comprises an attachment.

Example 20. The dental auxiliary of Example 18 or 19, wherein the dental auxiliary comprises an occlusally-oriented surface having a shape configured to reduce a force associated with placement of the palatal expander on the patient's teeth.

Example 21. The dental auxiliary of Example 20, wherein the occlusally-oriented surface is rounded.

Example 22. The dental auxiliary of Example 20 or 21, wherein the occlusally-oriented surface is sloped in a gingival direction.

Example 23. The dental auxiliary of any one of Examples 18 to 22, wherein the dental auxiliary comprises a gingivally-oriented surface having a shape configured to reduce a force associated with removal of the palatal expander from the patient's teeth.

Example 24. The dental auxiliary of Example 23, wherein the gingivally-oriented surface is rounded.

Example 25. The dental auxiliary of Example 23 or 24, wherein the gingivally-oriented surface is sloped in an occlusal direction.

Example 26. The dental auxiliary of any one of Examples 18 to 25, wherein the dental auxiliary has a partial ellipsoidal shape.

Example 27. The dental auxiliary of any one of Examples 18 to 26, wherein the dental auxiliary is configured to be received at least partially within a receptacle formed in the palatal expander.

Example 28. A computer-implemented method for designing a dental system for expanding a palate of a patient, the computer-implemented method comprising, by one or more processors:
accessing a digital representation of a dental arch of the patient;
determining, based on the digital representation of the dental arch, whether the dental arch has at least one characteristic associated with poor retention of a palatal expander on the dental arch; and
in response to a determination that the dental arch has the at least one characteristic, generating a digital representation of a dental auxiliary configured to be placed on a lingual surface of a tooth of the dental arch, wherein the dental auxiliary is configured to engage the palatal expander to facilitate retention of the palatal expander on the dental arch.

Example 29. The computer-implemented method of Example 28, wherein the at least one characteristic comprises buccal inclination of one or more teeth received by the palatal expander.

Example 30. The computer-implemented method of Example 28 or 29, wherein the at least one characteristic comprises one or more teeth received by the palatal expander having a crown height less than or equal to 4 mm.

Example 31. The computer-implemented method of any one of Examples 28 to 30, wherein the at least one characteristic comprises a palate depth less than or equal to 5 mm.

Example 32. The computer-implemented method of any one of Examples 28 to 31, wherein the at least one characteristic comprises a predicted retention force for the palatal expander that is below a threshold value.

Example 33. The computer-implemented method of any one of Examples 28 to 32, wherein the dental auxiliary comprises an attachment.

Example 34. The computer-implemented method of any one of Examples 28 to 33, wherein the dental auxiliary comprises an occlusally-oriented surface having a shape configured to reduce a force associated with placement of the palatal expander on the dental arch.

Example 35. The computer-implemented method of Example 34, wherein the occlusally-oriented surface is rounded.

Example 36. The computer-implemented method of Example 34 or 35, wherein the occlusally-oriented surface is sloped in a gingival direction.

Example 37. The computer-implemented method of any one of Examples 28 to 36, wherein the dental auxiliary comprises a gingivally-oriented surface having a shape configured to reduce a force associated with removal of the palatal expander from the dental arch.

Example 38. The computer-implemented method of Example 37, wherein the gingivally-oriented surface is rounded.

Example 39. The computer-implemented method of Example 37 or 38, wherein the gingivally-oriented surface is sloped in an occlusal direction.

Example 40. The computer-implemented method of any one of Examples 28 to 39, wherein the dental auxiliary has a partial ellipsoidal shape.

Example 41. The computer-implemented method of any one of Examples 28 to 40, further comprising generating a digital representation of the palatal expander, wherein the palatal expander comprises:
a first tooth engagement portion configured to receive one or more first teeth at a first side of the dental arch,
a second tooth engagement portion configured to receive one or more second teeth at a second side of the dental arch,
a palatal portion between the first and second tooth engagement portions, wherein the palatal portion is configured to apply forces to the first and second tooth engagement portions to expand the palate of the patient, and
a receptacle formed in the first tooth engagement portion or the second tooth engagement portion to receive the dental auxiliary.

Example 42. The computer-implemented method of Example 41, further comprising fabricating a palatal expander based on the generated digital representation of the palatal expander.

Example 43. The computer-implemented method of any one of Examples 28 to 42, wherein the dental auxiliary is a first dental auxiliary, and the computer-implemented method further comprises generating a digital representation of a second dental auxiliary configured to engage the palatal expander to facilitate retention of the palatal expander on the dental arch.

Example 44. The computer-implemented method of Example 43, wherein the second dental auxiliary is configured to be coupled to a buccal surface of the same tooth or of a different tooth of the patient.

Example 45. The computer-implemented method of Example 43, wherein the second dental auxiliary is configured to be coupled to a lingual surface of a different tooth of the patient.

Example 46. The computer-implemented method of any one of Examples 28 to 45, further comprising generating instructions for fabrication of a dental auxiliary based on the generated digital representation of the dental auxiliary.

Example 47. The computer-implemented method of any one of Examples 28 to 46, further comprising fabricating a dental auxiliary based on the generated digital representation of the dental auxiliary.

Example 48. The computer-implemented method of any one of Examples 28 to 47, further comprising transmitting the generated digital representation of the dental auxiliary for display on a client device.

Example 49. The computer-implemented method of any one of Examples 28 to 48, further comprising displaying the digital representation of the dental auxiliary on an output device.

Example 50. A computer-implemented method for designing a dental system for expanding a palate of a patient, the computer-implemented method comprising, by one or more processors:
accessing a digital representation of a dental arch of the patient;
determining, based on the digital representation of the dental arch, whether the dental arch has at least one characteristic associated with poor retention of a palatal expander on the dental arch; and
in response to a determination that the dental arch has the at least one characteristic, generating a digital representation of a palatal expander configured to engage a dental auxiliary on a lingual surface of a tooth of the dental arch, wherein the dental auxiliary is configured to facilitate retention of the palatal expander on the dental arch.

Example 51. The computer-implemented method of Example 50, wherein the at least one characteristic comprises buccal inclination of one or more teeth received by the palatal expander.

Example 52. The computer-implemented method of Example 50 or 51, wherein the at least one characteristic comprises one or more teeth received by the palatal expander having a crown height less than or equal to 4 mm.

Example 53. The computer-implemented method of any one of Examples 50 to 52, wherein the at least one characteristic comprises a palate depth less than or equal to 5 mm.

Example 54. The computer-implemented method of any one of Examples 50 to 53, wherein the at least one characteristic comprises a predicted retention force for the palatal expander that is below a threshold value.

Example 55. The computer-implemented method of any one of Examples 50 to 54, wherein the palatal expander comprises:
a first tooth engagement portion configured to receive one or more first teeth at a first side of the dental arch,
a second tooth engagement portion configured to receive one or more second teeth at a second side of the dental arch,
a palatal portion between the first and second tooth engagement portions, wherein the palatal portion is configured to apply forces to the first and second tooth engagement portions to expand the palate of the patient, and
a receptacle formed in the first tooth engagement portion or the second tooth engagement portion to receive the dental auxiliary.

Example 56. The computer-implemented method of Example 55, wherein the receptacle is formed in a lingual surface of the first tooth engagement portion or the second tooth engagement portion.

Example 57. The computer-implemented method of Example 55 or 56, wherein the palatal expander has a shape configured to reduce a force associated with placement of the palatal expander on the dental arch, a force associated with removal of the palatal expander from the dental arch, or a combination thereof.

Example 58. The computer-implemented method of any one of Examples 50 to 57, wherein the dental auxiliary comprises an attachment.

Example 59. The computer-implemented method of any one of Examples 50 to 58, wherein the dental auxiliary comprises an occlusally-oriented surface having a shape configured to reduce a force associated with placement of the palatal expander on the dental arch.

Example 60. The computer-implemented method of Example 59, wherein the occlusally-oriented surface is rounded.

Example 61. The computer-implemented method of Example 59 or 60, wherein the occlusally-oriented surface is sloped in a gingival direction.

Example 62. The computer-implemented method of any one of Examples 50 to 61, wherein the dental auxiliary comprises a gingivally-oriented surface having a shape configured to reduce a force associated with removal of the palatal expander from the dental arch.

Example 63. The computer-implemented method of Example 62, wherein the gingivally-oriented surface is rounded.

Example 64. The computer-implemented method of Example 62 or 63, wherein the gingivally-oriented surface is sloped in an occlusal direction.

Example 65. The computer-implemented method of any one of Examples 50 to 64, wherein the dental auxiliary has a partial ellipsoidal shape.

Example 66. The computer-implemented method of any one of Examples 50 to 65, wherein the dental auxiliary is a first dental auxiliary, and the palatal expander is configured to engage a second dental auxiliary on the dental arch.

Example 67. The computer-implemented method of Example 66, wherein the second dental auxiliary is configured to be coupled to a buccal surface of the same tooth or of a different tooth of the patient.

Example 68. The computer-implemented method of Example 66, wherein the second dental auxiliary is configured to be coupled to a lingual surface of a different tooth of the patient.

Example 69. The computer-implemented method of any one of Examples 50 to 68, further comprising generating instructions for fabrication of a palatal expander based on the generated digital representation of the palatal expander.

Example 70. The computer-implemented method of any one of Examples 50 to 69, further comprising fabricating a palatal expander based on the generated digital representation of the palatal expander.

Example 71. The computer-implemented method of any one of Examples 50 to 70, further comprising transmitting the generated digital representation of the palatal expander for display on a client device.

Example 72. The computer-implemented method of any one of Examples 50 to 71, further comprising displaying the digital representation of the palatal expander on an output device.

Example 73. The computer-implemented method of any one of Examples 50 to 72, further comprising generating a digital representation of the dental auxiliary.

Example 74. The computer-implemented method of any one of Examples 50 to 73, further comprising generating instructions for fabricating a dental auxiliary based on the generated digital representation of the dental auxiliary.

Example 75. A system for designing a dental system for expanding a palate of a patient, the system comprising:
one or more processors; and
a memory operably coupled to the one or more processors and storing instructions that, when executed by the one or more processors, cause the system to perform the computer-implemented method of any one of Examples 28 to 74.

Example 76. A non-transitory computer-readable storage medium comprising instructions that, when executed by one or more processors of a computing system, cause the computing system to perform the computer-implemented method of any one of Examples 28 to 74.

Example 77. A computer-implemented method for designing a dental system for expanding a palate of a patient, the computer-implemented method comprising, by one or more processors:
accessing patient data representing one or more characteristics of the patient;
accessing dental system data representing a palatal expander and a dental auxiliary for the patient, wherein the dental auxiliary is configured to be coupled to a tooth and to retain the palatal expander on a dental arch of the patient;
determining, based on the patient data and the dental system data, whether a force applied to the dental auxiliary during placement or removal of the palatal expander is likely to cause detachment of the dental auxiliary from the tooth;
in response to a determination that the applied force is likely to cause detachment of the dental auxiliary from the tooth, modifying the dental system data to reduce the applied force; and
generating one or more of a digital representation of the palatal expander or a digital representation of the dental auxiliary, based on the modified dental system data.

Example 78. The computer-implemented method of Example 77, wherein the applied force comprises a peak shear force applied to the dental auxiliary by the palatal expander during placement or removal of the palatal expander.

Example 79. The computer-implemented method of Example 77 or 78, wherein the determining comprises predicting whether the applied force will exceed a threshold value.

Example 80. The computer-implemented method of Example 79, wherein the threshold value is no more than 200 N.

Example 81. The computer-implemented method of any one of Examples 77 to 80, wherein the determining comprises predicting a discrepancy between the force applied to the dental auxiliary and a force applied to a dental auxiliary on a neighboring tooth.

Example 82. The computer-implemented method of any one of Examples 77 to 81, wherein the determining comprises predicting a likelihood that the dental auxiliary will be detached from the tooth during placement or removal of the palatal expander.

Example 83. The computer-implemented method of any one of Examples 77 to 82, wherein the determining is performed by inputting the patient data and the dental system data into a prediction model.

Example 84. The computer-implemented method of Example 83, wherein the prediction model comprises a reduced-order model.

Example 85. The computer-implemented method of Example 83 or 84, wherein the prediction model comprises a physics-based model.

Example 86. The computer-implemented method of any one of Examples 83 to 85, wherein the prediction model comprises a machine learning model.

Example 87. The computer-implemented method of any one of Examples 77 to 86, wherein the patient data comprises one or more of the following: characteristics of the dental arch of the patient, demographic information, or treatment information.

Example 88. The computer-implemented method of any one of Examples 77 to 87, wherein the patient data comprises one or more of the following: crown height, tooth angulation, tooth rotation, tooth inclination, tooth surface normal direction, arch width, arch form, palate depth, race, gender, age, medication, patient compliance, disease history, or treatment history.

Example 89. The computer-implemented method of any one of Examples 77 to 88, wherein the dental system data comprises one or more of the following: geometry of the palatal expander, material properties of the palatal expander, geometry of the dental auxiliary, location of the dental auxiliary, or material properties of the dental auxiliary.

Example 90. The computer-implemented method of any one of Examples 77 to 89, wherein the dental system data comprises one or more of the following: thickness of the palatal expander, stiffness of the palatal expander, slope of the dental auxiliary, prominence of the dental auxiliary, width of the dental auxiliary, length of the dental auxiliary, position of the dental auxiliary, or orientation of the dental auxiliary.

Example 91. The computer-implemented method of any one of Examples 77 to 90, wherein the dental system data represents a plurality of dental auxiliaries, and each dental auxiliary is configured to be coupled to a tooth to retain the palatal expander on the dental arch of the patient.

Example 92. The computer-implemented method of any one of Examples 77 to 91, wherein modifying the dental system data comprises one or more of the following: changing a geometry of a portion of the palatal expander, changing a stiffness of the palatal expander, changing a geometry of the dental auxiliary, changing a position of the dental auxiliary, or changing an orientation of the dental auxiliary.

Example 93. The computer-implemented method of any one of Examples 77 to 92, wherein the modification to the dental system data is configured to reduce a stiffness of a portion of the palatal expander proximate to the dental auxiliary.

Example 94. The computer-implemented method of any one of Examples 77 to 93, wherein the modification to the dental system data is configured to reduce interference between the palatal expander and the dental auxiliary during placement or removal of the palatal expander.

Example 95. The computer-implemented method of any one of Examples 77 to 94, where the modification to the dental system data is configured to reduce a discrepancy between the force applied to the dental auxiliary and a force applied to a dental auxiliary on a neighboring tooth.

Example 96. The computer-implemented method of any one of Examples 77 to 95, wherein the modification is performed by inputting the patient data and the dental system data into an optimization algorithm.

Example 97. The computer-implemented method of Example 96, wherein the optimization algorithm comprises a topology optimization algorithm.

Example 98. The computer-implemented method of any one of Examples 77 to 96, wherein the determining and modifying processes are iterated until modified dental system data that results in a force applied to the dental auxiliary during placement or removal of the palatal expander that is likely to avoid detachment of the dental auxiliary from the tooth is achieved.

Example 99. The computer-implemented method of any one of Examples 77 to 98, wherein the dental auxiliary comprises an attachment.

Example 100. The computer-implemented method of any one of Examples 77 to 99, wherein the palatal expander comprises:
a first tooth engagement portion configured to receive one or more first teeth at a first side of the dental arch,
a second tooth engagement portion configured to receive one or more second teeth at a second side of the dental arch,
a palatal portion between the first and second tooth engagement portions, wherein the palatal portion is configured to apply forces to the first and second tooth engagement portions to expand the palate of the patient, and
a receptacle formed in the first tooth engagement portion or the second tooth engagement portion to receive the dental auxiliary.

Example 101. The computer-implemented method of any one of Examples 77 to 100, further comprising one or more of:

generating instructions for fabrication of a palatal expander based on the digital representation of the palatal expander, or
generating instructions for fabrication of a dental auxiliary based on the digital representation of the dental auxiliary.

Example 102. The computer-implemented method of any one of Examples 77 to 101, further comprising one or more of:
fabricating a palatal expander based on the digital representation of the palatal expander, or
fabricating a dental auxiliary based on the digital representation of the dental auxiliary.

Example 103. The computer-implemented method of any one of Examples 77 to 102, further comprising transmitting the one or more of the digital representation of the palatal expander or the digital representation of the dental auxiliary for display on a client device.

Example 104. The computer-implemented method of any one of Examples 77 to 103, further comprising displaying the one or more of the digital representation of the palatal expander or the digital representation of the dental auxiliary to a user on an output device.

Example 105. A system for designing a dental system for expanding a palate of a patient, the system comprising:
one or more processors; and
a memory operably coupled to the one or more processors and storing instructions that, when executed by the one or more processors, cause the system to perform the computer-implemented method of any one of Examples 77 to 104.

Example 106. A non-transitory computer-readable storage medium comprising instructions that, when executed by one or more processors of a computing system, cause the computing system to perform the computer-implemented method of any one of Examples 77 to 104.

### CONCLUSION

Although many of the embodiments are described above with respect to systems, devices, and methods for palatal expansion, the technology is applicable to other applications and/or other approaches, such as other types of dental and/or orthodontic treatments. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-14.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A system for designing a dental system for expanding a palate of a patient, the system comprising:
one or more processors; and
a memory comprising instructions that, when executed by the one or more processors, cause the system to perform operations comprising:
accessing patient data representing one or more characteristics of the patient;
accessing dental system data representing a palatal expander and a dental auxiliary for the patient, wherein the dental auxiliary is configured to be coupled to a tooth and to retain the palatal expander on a dental arch of the patient;
determining, based on the patient data and the dental system data, whether a force applied to the dental auxiliary during placement or removal of the palatal expander is likely to cause detachment of the dental auxiliary from the tooth;
in response to a determination that the applied force is likely to cause detachment of the dental auxiliary from the tooth, modifying the dental system data to reduce the applied force; and
generating one or more of a digital representation of the palatal expander or a digital representation of the dental auxiliary, based on the modified dental system data.

2. The system of claim 1, wherein the applied force comprises a peak shear force applied to the dental auxiliary by the palatal expander during the placement or the removal of the palatal expander.

3. The system of claim 1, wherein the determining comprises predicting whether the applied force will exceed a threshold value.

4. The system of claim 3, wherein the threshold value is no more than 200 N.

5. The system of claim 1, wherein the determining comprises predicting a discrepancy between the force applied to the dental auxiliary and a force applied to a dental auxiliary on a neighboring tooth.

6. The system of claim 1, wherein the determining comprises predicting a likelihood that the dental auxiliary will be detached from the tooth during the placement or the removal of the palatal expander.

7. The system of claim 1, wherein the determining is performed by inputting the patient data and the dental system data into a prediction model.

8. The system of claim 7, wherein the prediction model comprises one or more of a reduced-order model, a physics-based model, or a machine learning model.

9. The system of claim 1, wherein the patient data comprises one or more of the following: characteristics of the dental arch of the patient, demographic information, or treatment information.

10. The system of claim 1, wherein the dental system data comprises one or more of the following: geometry of the palatal expander, material properties of the palatal expander, geometry of the dental auxiliary, location of the dental auxiliary, or material properties of the dental auxiliary.

11. The system of claim 1, wherein modifying the dental system data comprises one or more of the following: changing a geometry of a portion of the palatal expander, changing a stiffness of the palatal expander, changing a geometry of the dental auxiliary, changing a position of the dental auxiliary, or changing an orientation of the dental auxiliary.

12. The system of claim 1, wherein the modification to the dental system data is configured to reduce a stiffness of a portion of the palatal expander proximate to the dental auxiliary, reduce interference between the palatal expander and the dental auxiliary during the placement or the removal of the palatal expander, reduce a discrepancy between the force applied to the dental auxiliary and a force applied to a dental auxiliary on a neighboring tooth, or a combination thereof.

13. The system of claim 1, wherein the palatal expander comprises:
a first tooth engagement portion configured to receive one or more first teeth at a first side of the dental arch,
a second tooth engagement portion configured to receive one or more second teeth at a second side of the dental arch,
a palatal portion between the first and second tooth engagement portions, wherein the palatal portion is configured to apply forces to the first and second tooth engagement portions to expand the palate of the patient, and
a receptacle formed in the first tooth engagement portion or the second tooth engagement portion to receive the dental auxiliary.

14. The system of any claim 1, wherein the operations further comprise one or more of:
generating instructions for fabrication of a palatal expander based on the digital representation of the palatal expander, or
generating instructions for fabrication of a dental auxiliary based on the digital representation of the dental auxiliary.

15. The system of claim 1, wherein the operations further comprise causing a display of the one or more of the digital representation of the palatal expander or the digital representation of the dental auxiliary on an output device.

16. A computer-implemented method for designing a dental system for expanding a palate of a patient, the computer-implemented method comprising, by one or more processors:
accessing patient data representing one or more characteristics of the patient;
accessing dental system data representing a palatal expander and a dental auxiliary for the patient, wherein the dental auxiliary is configured to be coupled to a tooth and to retain the palatal expander on a dental arch of the patient;
determining, based on the patient data and the dental system data, whether a force applied to the dental auxiliary during placement or removal of the palatal expander is likely to cause detachment of the dental auxiliary from the tooth;
in response to a determination that the applied force is likely to cause detachment of the dental auxiliary from the tooth, modifying the dental system data to reduce the applied force; and
generating one or more of a digital representation of the palatal expander or a digital representation of the dental auxiliary, based on the modified dental system data.

17. The computer-implemented method of claim 16, wherein the determining comprises predicting whether the applied force will exceed a threshold value, predicting a discrepancy between the force applied to the dental auxiliary and a force applied to a dental auxiliary on a neighboring tooth, predicting a likelihood that the dental auxiliary will be detached from the tooth during the placement or the removal of the palatal expander, or a combination thereof.

18. The computer-implemented method of claim 16, wherein modifying the dental system data comprises one or more of the following: changing a geometry of a portion of the palatal expander, changing a stiffness of the palatal expander, changing a geometry of the dental auxiliary, changing a position of the dental auxiliary, or changing an orientation of the dental auxiliary.

19. The computer-implemented method of claim 16, wherein the modification to the dental system data is configured to reduce a stiffness of a portion of the palatal expander proximate to the dental auxiliary, reduce interference between the palatal expander and the dental auxiliary during the placement or the removal of the palatal expander, reduce a discrepancy between the force applied to the dental auxiliary and a force applied to a dental auxiliary on a neighboring tooth, or a combination thereof.

20. The computer-implemented method of claim 16, further comprising one or more of:
fabricating a palatal expander based on the digital representation of the palatal expander, or
fabricating a dental auxiliary based on the digital representation of the dental auxiliary.
